(19) United States
(12) Patent Application Publication
(10) Pub. No.: US 2006/0122322 A1
(43) Pub. Date: Jun. 8, 2006

(54) Aqueous polymer dispersions

(75) Inventors: Lysander Chrisstoffels, Limburgerhof (DE); Peter Hossel, Schifferstadt (DE); Marc Leduc, Speyer (DE); Claudia Wood, Weinheim (DE); Maximillian Angel, Schifferstadt (DE); Klemens Mathauer, Heidelberg (DE); Pulakesh Mukherjee, Mannheim (DE); Werner Gauweiler, Lustadt (DE); Henning Bolter, Wattenheim (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 10/540,097

(22) PCT Filed: Dec. 16, 2003
(86) PCT No.: PCT/EP03/14275

§ 371 Date: Jan. 26, 2006

(30) Foreign Application Priority Data
Dec. 20, 2002 (DE) 102 61 197.1

(51) Int. Cl. C08F 2/22

(52) U.S. Cl. 524/804

(57) ABSTRACT

Aqueous dispersion obtainable by free-radical polymerization of a) at least one N-vinyl-containing monomer b) at least one polymeric dispersant c) at least one polymeric precipitation agent d) at least one crosslinker e) optionally further monomers f) optionally at least one regulator g) optionally a buffer substance where the weight ratio of b) to c) is in the range from 1:50 to 1:0.02.

The present invention relates to aqueous dispersions of crosslinked water-soluble or water-swellable polymers based on monoethylenically unsaturated monomers which comprise a quaternized or quaternizable nitrogen atom or (meth)acrylamide groups by free-radical polymerization in an aqueous solution in the presence of one or more polymeric dispersants and one or more polymeric precipitation agents, to a process for their preparation, and to the use in cosmetic formulations, in particular in hair cosmetic formulations.

Cationic polymers are used as conditioning agents in cosmetic formulations. Requirements for hair conditioning agents are, for example, a considerable reduction in the required combing force in wet and also dry hair, good detangling upon the first comb through and good compatibility with further formulation components. In addition, cationic polymers prevent electrostatic charging of the hair.

In shampoos, primarily cationic cellulose derivatives (polyquaternium-10) or guar gum derivatives are used. However, a build-up effect is observed with these compounds, i.e. the hair is coated with the conditioner upon repeated use and feels weighted down.

For the conditioning and setting of keratinous substances, such as hair, nails and skin, use has also for years been made of synthetic polymers. Additionally, synthetic polymers are used in cosmetic formulations which comprise pigments or cosmetically effective active components as compatibility promoters for achieving a homogeneous, stable formulation.

For example, copolymers of acrylamide and dimethyldiallylammonium chloride (polyquaternium 7) are used. However, these have the disadvantage of high residual monomer contents since acrylamide and dimethyldiallylammonium chloride have unfavorable copolymerization parameters.

Despite extensive efforts, there continues to be a need for improvement with polymers for producing elastic hairstyles coupled with simultaneously strong hold, even at high atmospheric humidity, good ability to be washed out and good feel of the hair. The need for improvement likewise exists for polymers for producing readily combable, detanglable hair and for conditioning skin and hair with regard to their sensorily perceptible properties, such as feel, volume, handlability, etc. In addition, clear aqueous preparations of these polymers are desired which are accordingly characterized by good compatibility with other formulation constituents.

In addition, there is a need for polymers which are suitable as conditioning agents for cosmetic preparations and which can be prepared with a high solids content. Of particular interest are polymers which have a high solids content, have a low viscosity coupled with simultaneous retention of the performance properties (such as, for example, combability).

It is an object of the present invention to find a conditioning agent for cosmetic preparations, in particular shampoos, which does not have said disadvantages.

WO 02/15854 A1 describes the use of hydrophilic graft copolymers with N-vinylamide and/or open-chain N-vinylamide units in cosmetic formulations. None of the examples discloses polymers which have been prepared in the presence of at least 2 dispersants and a crosslinker.

EP 929 285 B1 describes the use of water-soluble copolymers as active ingredients in cosmetic formulations. As characteristic structural elements, these copolymers contain vinylcarboxamide units (e.g. N-vinylformamide), and imidazole and imidazolimum monomers. The described copolymers can be prepared in the presence of a crosslinker. EP 929 285 B1 does not describe copolymers which are prepared in the presence of polymeric dispersants.

WO 98/54234 A1 describes the preparation of water-soluble polymer dispersions of vinylamide monomers. The polymer dispersions described therein are prepared without crosslinkers.

WO 00/27893 A1 describes aqueous dispersions of uncrosslinked water-soluble polymers comprising N-vinylformamide and/or N-vinylacetamide.

WO 96/03969 A1 (EP 0 774 952) describes the preparation and use of uncrosslinked vinylformamide-containing polymers in hair cosmetic preparations. The preparation of these polymers takes place in water as solution polymer and as precipitation polymer in organic solvents.

U.S. Pat. No. 4,713,236 describes polymers comprising vinylamine groups as conditioning agents in hair cosmetics. The polymers are obtained by hydrolysis of the polymers containing vinylacetamide or vinylformamide which have been prepared as solution polymer or as precipitation polymer. Crosslinked polymers are not described.

WO 98/04596 A1 (EP 915 915) describes water-soluble polymers comprising vinylamine units and the cosmetic use thereof.

WO 02/34796 A1 describes a process for the preparation of aqueous dispersions of water-soluble uncrosslinked polymers.

WO 02/083085 A1 describes the use of dispersions of cationic, anionic or nonionic polymers in an aqueous salt solution in cosmetics. Crosslinked polymers are not described.

DE 29 24 663 describes a method of preparing aqueous dispersions of water-soluble polymer masses. The dispersions are obtained by polymerizing the monomers in an aqueous solution of a water-soluble polymer, during which it is absolutely imperative to observe the equilibrium ratio between the amount of monomer and the amount of water-soluble polymer. Crosslinked polymers are not described.

We have now found that the object according to the invention is achieved by aqueous dispersions which are obtainable by free-radical polymerization of

a) at least one N-vinyl-containing monomer and/or at least one (meth)acrylamide monomer

b) at least one polymeric dispersant

c) at least one polymeric precipitation agent

d) at least one crosslinker

e) optionally further monomers

f) optionally at least one regulator

where the weight ratio of b) to c) is in the range from 1:50 to 1:0.02.

The term (meth)acrylamide monomers refers to monomers containing both acrylamide groups and also methacrylamide groups.

In a preferred embodiment of the invention, a buffer is present during the polymerization as further component g). Suitable as component g) here is at least one substance which is able to buffer the pH during the polymerization, i.e. to keep the pH value during the polymerization at 5.0 to 10, in particular 6.0 to 8.0, preferably 6.5 to 7.5. Alternatively, by continuously measuring the pH and adding an acid or base in parallel, the pH can be kept in the preferred pH range.

Such buffer properties are found, for example, with salts of weak acids (see CD Römpp Chemie Lexikon—Version 1.0, Stuttgart/New York: Georg Thieme Verlag 1995).

Buffer substances which can in principle be used for adjusting the pH are all inorganic or organic bases, in particular those bases which are water-soluble.

In a preferred embodiment, the buffer substance is a salt of an acid chosen from the group consisting of carbonic acid, boric acid, acetic acid, citric acid and phosphoric acid, and/or a base chosen from the group consisting of alkali metal and alkaline earth metal hydroxides, ammonia, and primary, secondary and tertiary amines.

The salts of the abovementioned weak acids are preferably alkali metal and alkaline earth metal salts, particularly preferably sodium, potassium or magnesium salts. Very particularly preferred buffer substances are sodium acetate, sodium citrate, sodium pyrophosphate, potassium pyrophosphate, sodium dihydrogenphosphate, disodium hyrogenphosphate, sodium hydrogencarbonate and/or sodium borate. Additionally, it is also possible to use salts of unsaturated weak carboxylic acids, such as, for example, acrylic acid or methacrylic acid.

Examples of alkali metal and alkaline earth metal hydroxides are, inter alia, sodium hydroxide, potassium hydroxide, magnesium hydroxide, calcium hydroxide.

Examples of primary, secondary and tertiary amines are, inter alia, ethylamine, diethylamine, triethylamine, n-propylamine, di-n-propylamine, tri-n-propylamine, ethylenediamine, triethanolamine, aniline.

As well as the abovementioned buffer substances, the preferably used reagents which act as bases are sodium hydroxide, potassium hydroxide, calcium hydroxide and/or ammonia, particular preference being given to sodium hydroxide.

Said buffer substances can either be used individually or else in mixtures. To adjust the pH, the buffer substances can be added together or else in each case individually.

The dispersions obtainable according to the invention have, in a preferred embodiment, an LP value of less than or equal to 30%, in particular of less than or equal to 20%, preferably less than or equal to 10%, in particular less than or equal to 5%.

The determination of the LP value (light permeability) for aqueous polymer dispersions at a defined solids content is used to assess the clarity or color strength. The light permeability of the aqueous dispersions is measured relative to pure water with a cell length of 2.5 cm at 600 nm. The spectrophotometer (Hach: spectrophotometer DR/2000, measurement method “transmission”) is firstly adjusted to 100% with pure water. The cell is then rinsed a number of times with the dispersion, the dispersion is poured into the cell and the light permeability is read off in %.

In a preferred embodiment, components a) to d) are used in the following amounts. The data for the individual percent by weight refer here always to the total sum of components a) to d), which is set as 100%. If further possible components are present (e.g. components e) and f)), then the weights of these further components given are calculated based oh the sum of a) to d), which is set as 100%.

Component a) is preferably used in an amount of from 10 to 90% by weight, in particular 20 to 70% by weight, preferably 30 to 60% by weight.

Component b) is preferably used in an amount of from 1 to 50% by weight, in particular 2 to 30% by weight, preferably 3 to 20% by weight.

Component c) is preferably used in an amount of from 10 to 90% by weight, in particular 20 to 70% by weight, preferably 30 to 60% by weight.

Component d) is preferably used in an amount of from 0.01 to 10% by weight, in particular 0.05 to 5% by weight, preferably 0.1 to 1.5% by weight.

Particular preference is given to aqueous dispersions which are obtainable by free-radical polymerization of

10 to 90% by weight, in particular 20 to 70% by weight, preferably 30 to 60% by weight, of component a)

1 to 50% by weight, in particular 2 to 30% by weight, preferably 3 to 20% by weight, of component b)

10 to 90% by weight, in particular 20 to 70% by weight, preferably 30 to 60% by weight, of component c)

0.01 to 10% by weight, in particular 0.05 to 5% by weight, preferably 0.1 to 1.5% by weight, of component d)

with the proviso that the sum of a) to d) adds up to 100%.

If further components are present, these are preferably present in the following amounts (based on 100% of the sum of a) to d)
0-40% by weight, preferably 0-25% by weight, particularly preferably 0-15% by weight of component d)
0-5% by weight, preferably 0-2.5% by weight, particularly preferably 0-1.5% by weight, of component f)
0-5% by weight, preferably 0-3% by weight, of component g).

In the preparation of the aqueous dispersions, use is usually made of 400 to 25% water, in particular 150 to 50% water, based on the sum of all components (i.e. a) to d), and optionally e), f) and g), and further possible constituents.

The invention further provides a process for the preparation of aqueous dispersions where

a) at least one N-vinyl-containing monomer and/or at least one (meth)acrylamide monomer

b) at least one polymeric dispersant

c) at least one polymeric precipitation agent

d) at least one crosslinker

e) optionally further monomers

g) optionally a buffer substance

are reacted in the presence of at least one regulator and the weight ratio of b) to c) is in the range from 1:50 to 1:0.02.

Monomer a)

Suitable as N-vinyl-containing monomer a) are, for example, N-vinylamides and/or N-vinyllactams.

Suitable as N-vinyl-containing monomer a) are, for example, N-vinylamides of the formula (Ia) 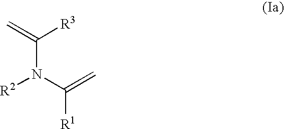
where R¹, R², R³═H or C₁- to C₆-alkyl.

To prepare the polymers used according to the invention, as open-chain N-vinylamide compound a) of the formula (Ia), use is made, for example, of the following monomers: N-vinylformamide, N-vinyl-N-methylformamide, N-vinylacetamide, N-vinyl-N-methylacetamide, N-vinyl-N-ethylacetamide, N-vinylpropionamide, N-vinyl-N-methylpropionamide and N-vinyl-butyramide.

Also suitable as N-vinyl-containing monomers a) are N-vinyllactams of the formula (IIa) 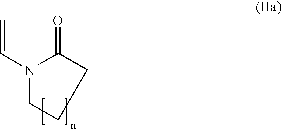
where n=1,2,3

Examples of monomers of the formula (IIa) are N-vinylpyrrolidone (n=1) and N-vinylcaprolactam (n=3).

Also suitable as N-vinyl-containing monomers a) are N-vinylpiperidone, N-vinyloxazolidone and N-vinyltriazole.

In a preferred embodiment of the invention, an N-vinylamide, in particular N-vinylformamide, is used as monomer a).

Also suitable as monomers a) are (meth)acrylamide monomers of the formula X 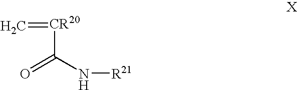
where R²⁰ is hydrogen or methyl and R²¹ is linear or branched C₁ to C₆-alkyl, linear or branched C₁-to C₆-alkyloxyalkyl, where the radicals may be mono- or polysubstituted by hydroxyl and/or carboxy and/or sulfonic acid groups. Here, C₁- to C₆-alkyl means methyl, ethyl, propyl, 1-methyl-ethyl, butyl, 1-methylpropyl, 2-methylpropyl, 1,1-dimethylethyl, pentyl, 1-methylbutyl, 2-methyl-butyl, 3-methylbutyl, 1,1-dimethylpropyl, 1,2-dimethylpropyl, 2,2-dimethylpropyl, 1-ethylpropyl, hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 1,1,2-trimethylpropyl, 1,2,2-trimethylpropyl, 1-ethyl-1-methylpropyl, 1-ethyl-2-methylpropyl.

Preferred (meth)acrylamide monomers of the formula X defined by the combinations of the radicals R²⁰ and R²¹ are given in table 1:

TABLE 2

| R²⁰ | R²¹ |
|---|---|
| H | H |
| H | CH(OH)COOH |
| H | C(CH₂OH)₃ |
| H | CH₂OH |
| H | CH₂OCH(CH₃)(C₂H₅) |
| H | CH(CH₃)₂ |
| H | CH₃ |
| H | C(CH₃)₂CH₂SO₃H or C(CH₃)₂CH₂SO₃⁻ |
| H | CH₂CHOHCH₃ |
| H | CH₂OCH₃ |
| H | C₂H₅ |
| CH₃ | H |
| CH₃ | CH₂OH |
| CH₃ | CH₃ |
| CH₃ | CH₂CHOHCH₃ |
| CH₃ | CH₂OCH₃ |
| CH₃ | C₂H₅ |
| CH₃ | CH(OH)COOH |
| CH₃ | C(CH₂OH)₃ |
| CH₃ | CH₂OCH(CH₃)(C₂H₅) |
| CH₃ | CH(CH₃)₂ |
| CH₃ | C(CH₃)₂CH₂SO₃H or C(CH₃)₂CH₂SO₃⁻ |

Particularly preferred (meth)acrylamides as monomers a) are acrylamide, 2-acrylamidoglycolic acid, N-(tris(hydroxymethyl)methyl)acrylamide, N-hydroxymethylacrylamide, N-methylacrylamide, N-isopropylacrylamide, 2-acrylamido-2-methyl-1-propanesulfonic acid, methacrylamide, N-ethylmethacrylamide, N-hydroxymethylmethacrylamide, N-(2-hydroxypropyl)-methacrylamide, N-methylmethacrylamide, N-isobutoxymethylacrylamide, N-methoxymethyl-methacrylamide.

In a very particularly preferred embodiment, the monomers a) used are acrylamide, methacrylamide, N-hydroxymethylacrylamide, N-(2-hydroxypropyl)methacrylamide, N-hydroxymethylmethacrylamide and N-isopropylacrylamide.

It is of course also possible to copolymerize mixtures of the respective monomers from the group a), such as, for example, mixtures of N-vinylformamide and N-vinylacetamide or mixtures of different (meth)acrylamide monomers or mixtures of N-vinyl-containing monomers and (meth)acrylamide monomers.

Polymeric Dispersant b)

The polymeric dispersants present as component b) in the aqueous dispersions differ with regard to composition from the water-soluble polymers obtainable by the free-radical polymerization of the monomers. The polymeric dispersant b) serves as dispersant of the water-soluble polymer which forms. Suitable as polymeric dispersant b) are thus all compounds which are able to disperse the water-soluble polymer which forms.

The average molar masses of the polymeric dispersants are preferably in the range from 500 to 20 000 000, in particular 1000 to 90 0000, preferably greater than 10 000 to 700 000.

The polymeric dispersants contain at least one functional group chosen from ether, hydroxyl, carboxyl, sulfone, sulfate ester, amino, imino, tert-amino, and/or quaternary ammonium groups. Examples of such compounds are: polyvinyl acetate, polyalkylene glycols, in particular polyethylene glycols, polyvinyl alcohol, polyvinylpyridine, polyethyleneimine, polyvinylimidazole, polyvinylsuccinimide and polydiallyldimethylammonium chloride, polyvinylpyrrolidone, polymers which contain at least 5% by weight of vinylpyrrolidone units, polymers which contain at least 50% by weight of vinyl alcohol units, oligosaccharides, polysaccharides, oxidatively, hydrolytically or enzymatically degraded polysaccharides, chemically modified oligo- or polysaccharides, such as, for example, carboxymethylcellulose, water-soluble starch and starch derivatives, starch esters, starch xanthanogenates, starch acetates, dextran, and mixtures thereof.

If the polymeric dispersants used are polyalkylene glycols, in particular polyethylene glycols and polypropylene glycols, it has proven advantageous to use compounds with a molecular weight of more than 10 000.

Suitable as polymeric dispersant b) are polymers which contain at least 50% by weight of vinyl alcohol units. Preferably, these polymers contain at least 70% by weight, very particularly preferably 80% by weight, of polyvinyl alcohol units. Such polymers are usually prepared by polymerization of a vinyl ester and subsequent at least partial alcoholysis, aminolysis or hydrolysis. Preference is given to vinyl esters of linear and branched C₁-C₁₂-carboxylic acids, and very particular preference is given to vinyl acetate. The vinyl esters can of course also be used in a mixture.

Suitable comonomers of the vinyl ester are, for example, N-vinylcaprolactam, N-vinylpyrrolidone, N-vinylimidazole, N-vinyl-2-methylimidazole, N-vinyl-4-methylimidazole, 3-methyl-1-vinylimidazolium chloride, 3-methyl-1-vinylimidazolium methylsulfate, diallylammonium chloride, styrene, alkyl styrenes.

Further suitable comonomers are, for example, monoethylenically unsaturated C₃-C₆-carboxylic acids, such as, for example, acrylic acid, methacrylic acid, crotonic acid, fumaric acid, and their esters, amides and nitriles, such as, for example, methyl acrylate, ethyl acrylate, methyl methacrylate, ethyl methacrylate, stearyl methacrylate, hydroxyethyl acrylate, hydroxypropyl acrylate, hydroxybutyl acrylate, hydroxyethyl methacrylate, hydroxypropyl methacrylate, hydroxyisobutyl acrylate, hydroxyisobutyl methacrylate, monomethyl maleate, dimethyl maleate, monoethyl maleate, diethyl maleate, 2-ethylhexyl acrylate, 2-ethylhexyl methacrylate, maleic anhydride, and half-esters thereof, alkylene glycol (meth)acrylates, acrylamide, methacrylamide, N-dimethylacrylamide, N-tert-butylacrylamide, acrylonitrile, methacrylonitrile, vinyl ethers, such as, for example, methyl, ethyl, butyl or dodecyl vinyl ether, cationic monomers, such as dialkylaminoalkyl (meth)acrylates and dialkylaminoalkyl (meth)acrylamides, such as dimethylaminoethyl acrylate, diethylaminoethyl acrylate, diethylaminoethyl methacrylate, and the salts of the last-mentioned monomers with carboxylic acids or mineral salts, and the quaternized products.

Preferred polymeric dispersants are polymers prepared by homopolymerization of vinyl acetate and subsequent at least partial hydrolysis, alcoholysis or aminolysis.

These polymeric dispersants are prepared by known processes, for example of solution, precipitation, suspension or emulsion polymerization using compounds which form free radicals under polymerization conditions. The polymerization temperatures are usually in the range from 30 to 200° C., preferably 40 to 110° C. Suitable initiators are, for example, azo and peroxy compounds, and the customary redox initiator systems, such as combinations of hydrogen peroxide and compounds with a reducing action, for example sodium sulfite, sodium bisulfite, sodium formaldehyde sulfoxylate and hydrazine. These systems can in addition optionally also comprise small amounts of a heavy metal salt.

To prepare these polymeric dispersants, the ester groups of the original monomers and optionally of further monomers are at least partially cleaved following polymerization by hydrolysis, alcoholysis or aminolysis. In the text below, this process step is generally referred to as saponification. The saponification takes place in a manner known per se by adding a base or acid, preferably by adding a sodium or potassium hydroxide solution in water and/or alcohol. Particular preference is given to using methanolic sodium or potassium hydroxide solutions. The saponification is carried out at temperatures in the range from 10 to 80° C., preferably in the range from 20 to 60° C. The degree of saponification depends on the amount of base or acid used, on the saponification temperature, the saponification time and the water content of the solution.

Particularly preferred polymeric dispersants are polymers prepared by homopolymerization of vinyl acetate and subsequent at least partial saponification. Such polymers containing polyvinyl alcohol units are available under the name Mowiol®.

Further particularly preferred polymeric dispersants b) are polymers which contain at least 5% by weight of vinylpyrrolidone units. Preferably, these polymers contain a vinylpyrrolidone fraction of at least 10% by weight, very particularly preferably of at least 30% by weight, in particular at least 50% by weight.

Suitable comonomers of vinylpyrrolidone for the synthesis of these polymers are, for example, N-vinyl acetate, N-vinylcaprolactam, N-vinylimidazole, N-vinyl-2-methylimidazole, N-vinyl-4-methylimidazole, 3-methyl-1-vinylimidazolium chloride, 3-methyl-1-vinylimidazolium methylsulfate, diallylammonium chloride, styrene, alkylstyrenes. Further suitable comonomers are, for example, monoethylenically unsaturated C₃-C₆-carboxylic acids such as, for example, acrylic acid, methacrylic acid, crotonic acid, fumaric acid, and their esters, amides and nitriles, such as, for example, methyl acrylate, ethyl acrylate, methyl methacrylate, ethyl methacrylate, stearyl methacrylate, hydroxyethyl acrylate, hydroxypropyl acrylate, hydroxybutyl acrylate, hydroxyethyl methacrylate, hydroxypropyl methacrylate, hydroxyisobutyl acrylate, hydroxyisobutyl methacrylate, monomethyl maleate, dimethyl maleate, monoethyl maleate, diethyl maleate, 2-ethylhexyl acrylate, 2-ethylhexyl methacrylate, maleic anhydride, and its half-esters, alkylene glycol (meth)acrylates, acrylamide, methacrylamide, N-dimethylacrylamide, N-tert-butylacrylamide, acrylonitrile, methacrylonitrile, vinyl ethers such as, for example, methyl, ethyl, butyl or dodecyl vinyl ether, cationic monomers, such as dialkylaminoalkyl(meth)acrylate and dialkylaminoalkyl(meth)acrylamides, such as dimethylaminoethyl acrylate, diethylaminoethyl acrylate, diethylaminoethyl methacrylate, and the salts of the last-mentioned monomers with carboxylic acids or mineral acids, and the quaternized products.

Particularly preferred comonomers of vinylpyrrolidone are vinyl acetate, N-vinylcaprolactam, N-vinylimidazole, 3-methyl-1-vinylimidazolium chloride, 3-methyl-1-vinylimidazolium methylsulfate and/or styrene.

These polymeric dispersants are prepared by known processes, for example of solution, precipitation, suspension or emulsion polymerization using compounds which form free radicals under the polymerization conditions. The polymerization temperatures are usually in the range from 30 to 200° C., preferably 40 to 110° C. Suitable initiators are, for example, azo and peroxy compounds, and the customary redox initiator systems, such as combinations of hydrogen peroxide and compounds with a reducing action, for example sodium sulfite, sodium bisulfite, sodium formaldehyde sulfoxylate and hydrazine. These systems can additionally optionally also comprise small amounts of a heavy metal salt.

A particularly preferred polymeric dispersant b) is polyvinylpyrrolidone.

In a preferred embodiment, the polymeric dispersant b) used is polyvinylpyrrolidione with a molecular weight of from 1000 to 10×10⁶, in particular 10 000 to 5×10⁶, preferably 10 000 to 7×10⁵.

All said polymeric dispersants can also be used in any mixtures with one another. A particularly preferred polymeric dispersant is a mixture of polymers which comprise at least 5% by weight of vinylpyrrolidone units and polyvinylpyrrolidone.

As polymeric dispersants, it is also possible to use natural substances which contain saccharide structures. Such natural substances are, for example, saccharides of vegetable or animal origin or products which are formed by metabolization by microorganisms, and degradation products thereof. Suitable compounds are, for example, oligosaccharides, polysaccharides, oxidatively, enzymatically or hydrolytically degraded polysaccharides, oxidatively hydrolytically degraded or oxidatively enzymatically degraded polysaccharides, chemically modified oligo- or polysaccharides and mixtures thereof.

Preferred products are the compounds specified in U.S. Pat. No. 5,334,287 in column 4, line 20 to column 5, line 45.

Polymeric Precipitation Agent c)

The precipitation agent present as component c) in the aqueous dispersions differs with regard to composition from the water-soluble polymers obtainable by the free-radical polymerization of the monomers. The polymeric precipitation agent c) reduces the solvation properties of the aqueous phase, resulting in displacement of the resulting water-soluble polymers from the aqueous phase into the disperse phase. The polymeric precipitation agent c) is thus incompatible with the water-soluble polymer.

Suitable polymeric precipitation agents c) are thus all compounds which reduce the solvation properties of the aqueous phase and lead to a displacement of the resulting water-soluble polymers from the aqueous phase into the disperse phase.

Water-soluble compounds are understood as meaning compounds which form clear solutions up to a concentration of 20% by weight in water, preferably up to a concentration of 50% by weight in water and particularly preferably up to a concentration of 70% by weight in water at 25° C.

The polymeric precipitation agent c) is not available in a relevant amount as a reactant, i.e. it does not result in relevant amounts in a covalent bond between the polymeric precipitation agent c) and the other monomers. Customary reaction conditions for achieving this are known to the person skilled in the art. For example, mention may be made of the choice of temperature during the polymerization. This is preferably chosen to be below 100° C., in particular below 80° C., preferably below 70° C. A further possible reaction condition is the choice of water fraction in the polymerization reaction. Water contents of ≧20% by weight, in particular ≧30%, preferably ≧40% are advantageous. The water content is given based on the sum of all constituents (i.e. on the sum of a) to d) and optionally e), f) and g), and further constituents), which is set as 100.

The average molar mass of the polymeric precipitation agent is preferably in the range from 300 to 100 000, in particular 1000 to 30 000, preferably 1000 to 10 000.

Suitable as polymeric precipitation agents c) are, in particular, water-soluble polyether-containing compounds. In this connection, it is possible to use either polyalkylene oxides based on ethylene oxide, propylene oxide, butylene oxide and further alkylene oxides, and also polyglycerol. In this connection, the structural units can either by homopolymers or random copolymers and block copolymers.

As polymeric precipitation agents, preference is given to using compounds of the following formula (Ib). 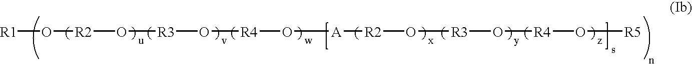
in which the variables, independently of one another, have the following meanings:
R¹ is hydrogen, C₁-C₂₄-alkyl, R⁶—C(═O)—, R⁶—NH—C(═O)—, polyalcohol radical;
R⁵ is hydrogen, C₁-C₂₄-alkyl, R⁶—C(═O)—, R⁶—NH—C(═O)—;
R² to R⁴ are —(CH₂)₂—, —(CH₂)₃—, —(CH₂)₄—, —CH₂—CH(R⁶)—, —CH₂—CHOR⁷—CH₂—;
R⁶ is C₁-C₂₄-alkyl;
R⁷ is hydrogen, C₁-C₂₄-alkyl, R⁶—C(═O)—, R⁶—NH—C(═O)—;
A-C(═O)—O, —C(═O)—B—C(═O)—O, —CH₂—CH(—OH)—B—CH(—OH)—CH₂—O, —C(═O)—NH—B—NH—C(═O)—O; 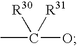
B is —(CH₂)ₜ—, arylene, optionally substituted;
R³⁰, R³¹ are hydrogen, C₁-C₂₄-alkyl, C₁-C₂₄-hydroxyalkyl, benzyl or phenyl;
n is 1 when R¹ is not a polyalcohol radical or
n is 1 to 1000 when R¹ is a polyalcohol radical
s=0 to 1000; t=1 to 12; u=1 to 5000; v=0 to 5000; w=0 to 5000; x=0 to 5000; y=0 to 5000; z=0 to 5000.

Alkyl radicals for R⁶ and R³⁰ and R³¹ which may be mentioned are branched or unbranched C₁-C₂₄-alkyl chains, preferably methyl, ethyl, n-propyl, 1-methylethyl, n-butyl, 1-methylpropyl, 2-methylpropyl, 1,1-dimethylethyl, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methyl-pentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, 2-ethylhexyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl or n-eicosyl.

Preferred representatives of the abovementioned alkyl radicals which may be mentioned are branched or unbranched C₁-C₁₂-, particularly preferably C₁-C₆-alkyl chains.

Preferred polymeric precipitation agents c) are polyalkylene glycols, such as, for example, polyethylene glycols and polypropylene glycols. Particular preference is given to polyethylene glycols.

Silicone derivatives can also be used as polymeric precipitation agent c). Suitable silicone derivatives are the compounds known under the INCI name Dimethicone copolyols or silicone surfactants, such as, for example, those available under the trade names Abil® (T. Goldschmidt), Alkasil® (Rhône-Poulenc), Silicone Polyol Copolymer® (Genesee), Belsil® (Wacker), Silwet® (Witco, Greenwich, Conn., USA) or Dow Corning (Dow Corning). These include compounds with the CAS numbers 64365-23-7; 68937-54-2; 68938-54-5; 68937-55-3.

Preferred representatives of such polyether-containing silicone derivatives are those which contain the following structural elements:

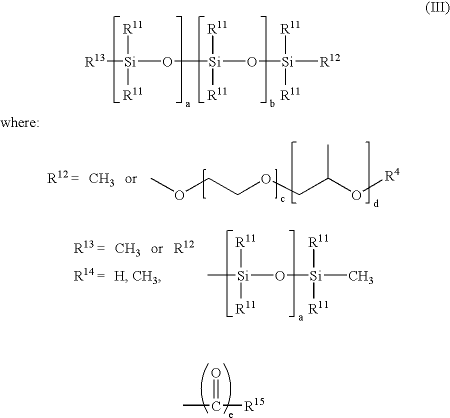

R¹⁵ is an organic radical of 1 to 40 carbon atoms which can contain amino, carboxylic acid or sulfonate groups or, for the case e=0, is also the anion of an inorganic acid,
and where the radicals R¹¹ may be identical or different, and originate either from the group of aliphatic hydrocarbons having 1 to 20 carbon atoms, cyclic aliphatic hydrocarbons having 3 to 20 carbon atoms, are of an aromatic nature or are identical to R¹⁶, where: 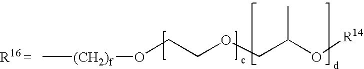
with the proviso that at least one of the radicals R¹¹, R¹² or R¹³ is a polyalkylene oxide-containing radical according to the above definition,
and f is an integer from 1 to 6,
a and b are integers such that the molecular weight of the polysiloxane block is between 300 and 30 000,
c and d may be integers between 0 and 50, with the proviso that the sum of c and d is greater than 0, and e is 0 or 1.

Preferred radicals R¹² and R¹⁶ are those in which the sum of c+d is between 5 and 30.

Preferably, the groups R¹¹ are chosen from the following group: methyl, ethyl, propyl, butyl, isobutyl, pentyl, isopentyl, hexyl, octyl, decyl, dodecyl and octadecyl, cycloaliphatic radicals, specifically cyclohexyl, aromatic groups, specifically phenyl or naphthyl, mixed aromatic-aliphatic radicals, such as benzyl or phenylethyl, and tolyl and xylyl and R¹⁶.

Particularly suitable radicals R¹⁴ are those in which, in the case R¹⁴═(CO)ₑ—R¹⁵, R¹⁵ is any alkyl, cycloalkyl or aryl radical which has between 1 and 40 carbon atoms and which can carry further ionogenic groups, such as NH₂, COOH, SO₃H.

Preferred inorganic radicals R¹⁵ are, for the case e=0, phosphate and sulfate.

Particularly preferred polyether-containing silicone derivatives are those of the structure: 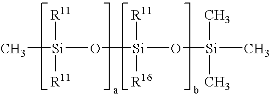
Ratio of b) to c)

The weight ratio of the sum of the polymeric dispersants b) to the sum of the polymeric precipitation agents c) is in the range from 1:50 to 1:0.02, in particular from 1:20 to 1:0.05, particularly preferably in the range from 1:10 to 1:0.1, in particular 1:10 to 1:0.5, preferably 1:10 to 1:1.

In a preferred embodiment of the invention, the polymeric dispersants b) used are polymers which contain at least 5% by weight of vinylpyrrolidone units and/or polyvinylpyrrolidone, and the polymeric precipitation agent c) used is polyethylene glycols.

In a preferred embodiment of the invention, the weight ratio of the amounts of polymeric dispersant b) and polymeric precipitation agent c) to the sum of the remaining monomers is chosen such that the ratio is in the range from 10:1 to 1:0.1, in particular in the range from 5:1 to 1:0.5. The sum of the remaining monomers arises from the sum of a) and d) and optionally e) and f). It corresponds to the sum of all further constituents without added water.

Crosslinker d)

Monomers d) which have a crosslinking function are compounds with at least 2 ethylenically unsaturated, nonconjugated double bonds in the molecule.

Suitable crosslinkers d) are, for example, acrylic esters, methacrylic esters, allyl ethers or vinyl ethers or at least dihydric alcohols. The OH groups of the parent alcohols may here be completely or partially etherified or esterified; the crosslinkers contain at least two ethylenically unsaturated groups.

Examples of the parent alcohols are dihydric alcohols, such as 1,2-ethanediol, 1,2-propanediol, 1,3-propanediol, 1,2-butanediol, 1,3-butanediol, 2,3-butanediol, 1,4-butanediol, but-2-ene-1,4-diol, 1,2-pentanediol, 1,5-pentanediol, 1,2-hexanediol, 1,6-hexanediol, 1,10-decanediol, 1,2-dodecanediol, 1,12-dodecanediol, neopentyl glycol, 3-methylpentane-1,5-diol, 2,5-dimethyl-1,3-hexanediol, 2,2,4-trimethyl-1,3-pentanediol, 1,2-cyclohexanediol, 1,4-cyclohexanediol, 1,4-bis(hydroxymethyl)cyclohexane, neopentyl glycol monohydroxypivalate, 2,2-bis(4-hydroxy-phenyl)propane, 2,2-bis[4-(2-hydroxypropyl)phenyl]propane, diethylene glycol, triethylene glycol, tetraethylene glycol, dipropylene glycol, tripropylene glycol, tetrapropylene glycol, 3-thiopentane-1,5-diol, and also polyethylene glycols, polypropylene glycols and polytetrahydrofurans with molecular weights of in each case 200 to 10 000. Apart from the homopolymers of ethylene oxide or propylene oxide, it is also possible to use block copolymers of ethylene oxide or propylene oxide or copolymers which contain ethylene oxide and propylene oxide groups in incorporated form. Examples of parent alcohols with more than two OH groups are trimethylolpropane, glycerol, pentaerythritol, 1,2,5-pentanetriol, 1,2,6-hexanetriol, triethoxycyanuric acid, sorbitan, sugars such as sucrose, glucose, mannose. The polyhydric alcohols can of course also be used following reaction with ethylene oxide or propylene oxide, in the form of the corresponding ethoxylates or propoxylates. The polyhydric alcohols can also firstly be converted into the corresponding glycidyl ethers by reaction with epichlorohydrin.

Further suitable crosslinkers are the vinyl esters or the esters of monohydric, unsaturated alcohols with ethylenically unsaturated C₃- to C₆-carboxylic acids, for example acrylic acid, methacrylic acid, itaconic acid, maleic acid or fumaric acid. Examples of such alcohols are allyl alcohol, 1-buten-3-ol, 5-hexen-1-ol, 1-octen-3-ol, 9-decen-1-ol, dicyclopentenyl alcohol, 10-undecen-1-ol, cinnamyl alcohol, citronellol, crotyl alcohol or cis-9-octadecen-1-ol. It is, however, also possible to esterify the monohydric, unsaturated alcohols with polyhydric carboxylic acids, for example malonic acid, tartaric acid, trimellitic acid, phthalic acid, terephthalic acid, citric acid or succinic acid.

Further suitable crosslinkers are esters of unsaturated carboxylic acids with the above-described polyhydric alcohols, for example oleic acid, crotonic acid, cinnamic acid or 10-undecenoic acid.

Suitable as monomers d) are also straight-chain or branched, linear or cyclic, aliphatic or aromatic hydrocarbons which have at least two double bonds which, in the case of aliphatic hydrocarbons, must not be conjugated, e.g. divinylbenzene, divinyltoluene, 1,7-octadiene, 1,9-decadiene, 4-vinyl-1-cyclohexene, trivinylcyclohexane or polybutadienes with molecular weights of from 200 to 20 000.

Suitable crosslinkers are also the acrylamides, methacrylamides and N-allylamines of at least dihydric amines. Such amines are, for example, 1,2-diaminomethane, 1,2-diaminoethane, 1,3-diaminopropane, 1,4-diaminobutane, 1,6-diaminohexane, 1,12-dodecanediamine, piperazine, diethylenetriamine or isophoronediamine. Likewise suitable are the amides of allylamine and unsaturated carboxylic acids, such as acrylic acid, methacrylic acid, itaconic acid, maleic acid, or at least dihydric carboxylic acids, as has been described above.

Also suitable are triallylamine and triallylmonoalkylammonium salts, e.g. triallylmethylammonium chloride or methylsulfate, as crosslinker.

Also suitable are N-vinyl compounds of urea derivatives, at least divalent amides, cyanurates or urethanes, for example of urea, ethyleneurea, propyleneurea or tartardiamide, e.g. N,N′-divinylethyleneurea or N,N′-divinylpropyleneurea.

Further suitable crosslinkers are divinyldioxane, tetraallylsilane or tetravinylsilane.

It is of course also possible to use mixtures of the abovementioned compounds. Preference is given to using those crosslinkers which are soluble in the monomer mixture.

Particularly preferred crosslinkers are, for example, methylenbisacrylamide, triallylamine and triallylalkylammonium salts, divinylimidazole, pentaerythritol triallyl ether, N,N′-divinylethylene-urea, reaction products of polyhydric alcohols with acrylic acid or methacrylic acid, methacrylic esters and acrylic esters of polyalkylene oxides or polyhydric alcohols which have been reacted with ethylene oxide and/or propylene oxide and/or epichlorohydrin.

Very particularly preferred crosslinkers are pentaerythritol triallyl ether, methylenebisacrylamide, N,N′-divinylethyleneurea, triallylamine and triallylmonoalkylammonium salts, and acrylic esters of glycol, butanediol, trimethylolpropane or glycerol or acrylic esters of glycol, butanediol, trimethylolpropane or glycerol reacted with ethylene oxide and/or epichlorohydrin.

Further Monomers e)

In a preferred embodiment of the present invention, further monomers may be present in the free-radical polymerization reaction.

Suitable further monomers e) different from a) are N-vinyllactams, e.g. N-vinylpiperidone, N-vinylpyrrolidone and N-vinylcaprolactam, N-vinylacetamide, N-methyl-N-vinylacetamide, N-vinylformamide, (meth)acrylamide monomers different from a) such as acrylamide, methacrylamide, N,N-dimethylacrylamide, N-methylolmethacrylamide, N-vinyloxazolidone, N-vinyltriazole, hydroxyalkyl (meth)acrylates, e.g. hydroxyethyl (meth)acrylate and hydroxypropyl (meth)acrylates, or alkyl ethylene glycol (meth)acrylates having 1 to 50 ethylene glycol units in the molecule. As monomers e), particular preference is given to using N-vinyllactams. Very particular preference is given to N-vinylpyrrolidone.

Also suitable are N-vinylimidazoles different from monomer a) and of the formula (I) 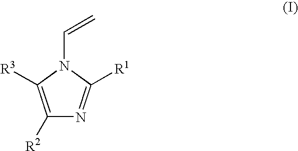
in which R¹ to R³ is hydrogen, C₁-C₄-alkyl or phenyl, diallylamines of the formula (II), and dialkylaminoalkyl (meth)acrylates and dialkylaminoalkyl(meth)acrylamides of the formula (IIIa), e.g. dimethylaminoethyl methacrylate or dimethylaminopropylmethacrylamide.

Also suitable are unsaturated carboxylic acids and unsaturated anhydrides, e.g. acrylic acid, methacrylic acid, crotonic acid, itaconic acid, maleic acid, fumaric acid or their corresponding anhydrides, and unsaturated sulfonic acids different from monomer a), such as, for example, acrylamidomethylpropanesulfonic acid, and the salts of the unsaturated acids, such as, for example, the alkali metal or ammonium salts.

Further monomers e) which may be mentioned are C₁-C₄₀-alkyl esters of (meth)acrylic acid, where the esters are derived from linear, branched-chain or carbocyclic alcohols, e.g. methyl (meth)acrylate, ethyl (meth)acrylate, tert-butyl (meth)acrylate, isobutyl (meth)acrylate, n-butyl (meth)acrylate, stearyl (meth)acrylate, or esters of alkoxylated fatty alcohols, e.g. C₁-C₄₀-fatty alcohols, reacted with ethylene oxide, propylene oxide or butylene oxide, in particular C₁₀-C₁₈-fatty alcohols reacted with 3 to 150 ethylene oxide units. Also suitable are N-alkyl-substituted acrylamides different from monomer a) with linear, branched-chain or carbocyclic alkyl radicals, such as N-tert-butylacrylamide, N-butylacrylamide, N-octylacrylamide, N-tert-octylacrylamide.

Also suitable are styrene, vinyl and allyl esters of C₁-C₄₀-carboxylic acids, which may be linear, branched-chain or carbocyclic, e.g. vinyl acetate, vinyl propionate, vinyl neononanoate, vinyl neoundecanoic acid, vinyl t-butyl-benzoate, alkyl vinyl ether, for example methyl vinyl ether, ethyl vinyl ether, butyl vinyl ether, stearyl vinyl ether.

Also suitable are (meth)acrylamides different from monomer a), such as N-tert-butyl(meth)-acrylamide, N-butyl(meth)acrylamide, N-octyl(meth)acrylamide, N-tert-octyl(meth)acrylamide and N-alkyl-substituted acrylamides different from monomer a) with linear, branched-chain or carbocyclic alkyl radicals, where the alkyl radical can have the meanings given above for R⁴.

Suitable monomers (e) are, in particular, C₁ to C₂₄- very particularly C₁ to C₁₀-alkyl esters of (meth)acrylic acid, e.g. methyl (meth)acrylate, ethyl (meth)acrylate, tert-butyl (meth)acrylate, isobutyl (meth)acrylate, n-butyl (meth)acrylate and (meth)acrylamides different from monomer a), such as N-tert-butylacrylamide or N-tert-octylacrylamide.

In a preferred embodiment of the invention, the further monomers e) used are cationic and/or quaternizable monomers. Suitable further monomers are the N-vinylimidazole derivatives of the formula (I) in which R¹ to R³ are hydrogen, C₁-C₄-alkyl or phenyl.

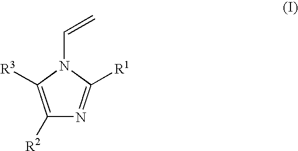

Also suitable are diallylamines of the formula (II) in which R⁴ is C₁-C₂₄-alkyl

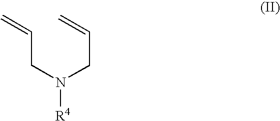

Also suitable are N,N-dialkylaminoalkyl acrylates and methacrylates and N,N-dialkylamino-alkylacrylamides and -methacrylamides of the formula (IIIa), 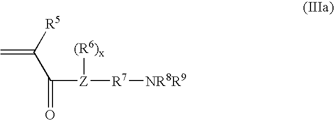
where R⁵, R⁶, independently, are a hydrogen atom or a methyl radical, R⁷ is an alkylene radical having 1 to 24 carbon atoms, optionally substituted by alkyl radicals, and R⁸, R⁹ are C₁-C₂₄-alkyl radicals. Z is a nitrogen atom together with x=1, or is an oxygen atom together with x=0.

Examples of compounds of the formula (I) are given in table 2 below.

TABLE 2

| R¹ | R² | R³ |
|---|---|---|
| H | H | H |
| Me | H | H |
| H | Me | H |
| H | H | Me |
| Me | Me | H |
| H | Me | Me |
| Me | H | Me |
| Ph | H | H |
| H | Ph | H |
| H | H | Ph |
| Ph | Me | H |
| Ph | H | Me |
| Me | Ph | H |
| H | Ph | Me |
| H | Me | Ph |
| Me | H | Ph |

Me = methyl;
Ph = phenyl

Further monomers of the formula (I) which can be used are the ethyl, propyl or butyl analog of the methyl-substituted 1-vinylimidazoles listed in table 2.

Examples of compounds of the formula (II) are diallylamines in which R⁴ is methyl, ethyl, iso- or n-propyl, iso-, n- or tert-butyl, pentyl, hexyl, heptyl, octyl, nonyl or decyl. Examples of longer-chain radicals R⁴ are undecyl, dodecyl, tridecyl, pentadecyl, octadecyl and icosayl.

Examples of compounds of the formula (IIIa) are N,N-dimethylaminomethyl (meth)acrylate; N,N-diethylaminomethyl (meth)acry late; N,N-dimethylaminoethyl (meth)acrylate; N,N-diethylaminoethyl (meth)acrylate; N,N-dimethylaminobutyl (meth)acrylate; N,N-diethylaminobutyl (meth)acrylate, N,N-dimethylaminohexyl (meth)acrylate; N,N-dimethylaminooctyl (meth)acrylate, N,N-dimethylaminododecyl (meth)acrylate; N-[3-(dimethylamino)propyl]methacrylamide, N-[3-(dimethylamino)propyl]acrylamide; N-[3-(dimethylamino)butyl]methacrylamide, N-[8-(dimethylamino)octyl]methacrylamide; N-[12-(dimethylamino)dodecyl]methacrylamide, N-[3-(diethylamino)propyl]methacrylamide; N-[3-(diethylamino)propyl]acrylamide.

Preferred examples of further monomers are 3-methyl-1-vinylimidazolium chloride and methosulfate, dimethyldiallylammonium chloride and N,N-dimethylaminoethyl methacrylate and N-[3-(dimethylamino)propyl]methacrylamide, which have been quaternized by methyl chloride, dimethyl sulfate or diethyl sulfate.

Particularly preferred monomers are 3-methyl-1-vinylimidazolium chloride and methosulfate and dimethyldiallylammonium chloride, very particular preference being given to 3-methyl-1-vinylimidazolium chloride and methosulfate.

The further monomers can either be used in quaternized form as monomers or be polymerized in nonquaternized form, where, in the latter case, the resulting polymer is either quaternized or protonated.

Suitable for the quaternization of the compounds of the formula (I) to (IIIa) are, for example, alkyl halides having 1 to 24 carbon atoms in the alkyl group, e.g. methyl chloride, methyl bromide, methyl iodide, ethyl chloride, ethyl bromide, propyl chloride, hexyl chloride, dodecyl chloride, lauryl chloride and benzyl halides, in particular benzyl chloride and benzyl bromide. Further suitable quaternizing agents are dialkyl sulfates, in particular dimethyl sulfate or diethyl sulfate. The quaternization of the basic monomers of the formula (I) to (IIIa) can also be carried out with alkylene oxides, such as ethylene oxide or propylene oxide in the presence of acids.

The quaternization of the monomer or of a polymer with one of said quaternizing agents can take place in accordance with generally known methods.

Preferred quaternizing agents are: methyl chloride, dimethyl sulfate or diethyl sulfate.

The quaternization of the polymer can take place completely or else only partially. The proportion of quaternized monomers within the polymer can vary over a wide range and is, for example, about 20 to 100 mol %.

Suitable for the protonation are, for example, mineral acids, such as HCl, H₂SO₄, H₃PO₄, and monocarboxylic acids, such as, for example, formic acid and acetic acid, dicarboxylic acids and multifunctional carboxylic acids, such as, for example, oxalic acid, lactic acid and citric acid, and all other proton-releasing compounds and substances which are able to protonate the corresponding vinylimidazole or diallylamine. In particular, water-soluble acids are suitable for the protonation.

The protonation of the polymer can either take place after the polymerization, or during formulation of the cosmetic preparation, during which a physiologically compatible pH is usually established.

Protonation is understood as meaning that at least some of the protonatable groups of the polymer, preferably 20 to 100 mol %, is protonated, resulting in a cationic overall charge of the polymer.

Regulator f)

The free-radical polymerization can be carried out in the presence of at least one regulator f). Regulators (polymerization regulators) is the term used to describe compounds with high transfer constants. Regulators accelerate chain-transfer reactions and thus bring about a reduction in the degree of polymerization of the resulting polymers without influencing the net rate of reaction.

Among the regulators, a distinction can be made between mono-, bi- or polyfunctional regulators, depending on the number of functional groups within the molecule which can lead to one or more chain-transfer reactions. Suitable regulators are described, for example, in detail by K. C. Berger and G. Brandrup in J. Brandrup, E. H. Immergut, Polymer Handbook, 3rd edition, John Wiley & Sons, New York, 1989, p. II/81-II/141.

Suitable regulators are, for example, aldehydes, such as formaldehyde, acetaldehyde, propionaldehyde, n-butyraldehyde, isobutyraldehyde.

In addition, regulators which may also be used are: formic acid, its salts or esters, 2,5-diphenyl-1-hexene, ammonium formate, hydroxylammonium sulfate, and hydroxylammonium phosphate.

Further suitable regulators are halogen compounds, such as alkyl halides, such as tetrachloromethane, chloroform, bromotrichloromethane, bromoform, allyl bromide, and benzyl compounds, such as benzyl chloride or benzyl bromide.

Further suitable regulators are allyl compounds, such as, for example, allyl alcohol, functional allyl ethers, such as allyl ethoxylates, alkyl allyl ether, or glycerol monoallyl ether.

As regulators, preference is given to using compounds which comprise sulfur in bonded form.

Compounds of this type are, for example, inorganic hydrogensulfites, disulfites and dithionites or organic sulfides, disulfides, polysulfides, sulfoxides, sulfones. The following regulators are mentioned by way of example: di-n-butyl sulfide, di-n-octyl sulfide, diphenyl sulfide, thiodiglycol, ethylthioethanol, diisopropyl disulfide, di-n-butyl disulfide, di-n-hexyl disulfide, diacetyl disulfide, diethanol sulfide, di-t-butyl trisulfide, dimethyl sulfoxide, dialkyl sulfide, dialkyl disulfide and/or diaryl sulfide.

Particular preference is given to organic compounds which comprise sulfur in bonded form.

Compounds preferably used as polymerization regulators are thiols (compounds which comprise sulfur in the form of SH groups, also referred to as mercaptans). Preferred regulators are mono-, bi- and polyfunctional mercaptans, mercaptoalcohols and/or mercaptocarboxylic acids.

Examples of these compounds are allyl thioglycolates, ethyl thioglycolate, cysteine, 2-mercaptoethanol, 1,3-mercaptopropanol, 3-mercaptopropane-1,2-diol, 1,4-mercaptobutanol, mercaptoacetic acid, 3-mercaptopropionic acid, mercaptosuccinic acid, thioglycerol, thioacetic acid, Thiourea and alkyl mercaptans, such as n-butyl mercaptan, n-hexyl mercaptan or n-dodecyl mercaptan.

Particularly preferred thiols are cysteine, 2-mercaptoethanol, 1,3-mercaptopropanol, 3-mercaptopropane-1,2-diol, thioglycerol, thiourea.

Examples of bifunctional regulators which comprise two sulfurs in bonded form are bifunctional thiols, such as, for example, dimercaptopropanesulfonic acid (sodium salt), dimercaptosuccinic acid, dimercapto-1-propanol, dimercaptoethane, dimercaptopropane, dimercaptobutane, dimercaptopentane, dimercaptohexane, ethylene glycol bis-thioglycolates and butanediol bis-thioglycolate.

Examples of polyfunctional regulators are compounds which contain more than two sulfurs in bonded form. Examples thereof are trifunctional and/or tetrafunctional mercaptans.

Preferred trifunctional regulators are trifunctional mercaptans, such as, for example, trimethylolpropane tris(2-mercaptoethanate), trimethylolpropane tris(3-mercaptopropionate), trimethylolpropane tris(4-mercaptobutanate), trimethylolpropane tris(5-mercaptopentanate), trimethylolpropane tris(6-mercaptohexanate), trimethylolpropane tris(2-mercaptoacetate).

Glyceryl thioglycolate, glyceryl thiopropionate, glyceryl thioethylate, glyceryl thiobutanate. 1,1,1-propanetriyl tris(mercaptoacetate), 1,1,1-propanetriyl tris(mercaptoethanate), 1,1,1-propanetriyl tris(mercaptoproprionate), 1,1,1-propanetriyl tris(mercaptobutanate) 2-hydroxymethyl-2-methyl-1,3-propanediol tris(mercaptoacetate), 2-hydroxymethyl-2-methyl-1,3-propanediol tris(mercaptoethanate), 2-hydroxymethyl-2-methyl-1,3-propanediol tris(mercaptopropionate), 2-hydroxymethyl-2-methyl-1,3-propanediol tris(mercaptobutanate).

Particularly preferred trifunctional regulators are glyceryl thioglycolate, trimethylolpropane tris(2-mercaptoacetate), 2-hydroxymethyl-2-methyl-1,3-propanediol tris(mercaptoacetate).

Preferred tetrafunctional mercaptans are pentaerythritol tetraquis(2-mercaptoacetate), pentaerythritol tetraquis(2-mercaptoethanate), pentaerythritol tetraquis(3-mercaptopropionate), pentaerythritol tetraquis(4-mercaptobutanate), pentaerythritol tetraquis(5-mercaptopentanate), pentaerythritol tetraquis(6-mercaptohexanate).

Further suitable polyfunctional regulators are Si compounds which arise by the reaction of compounds of the formula (IVa). Further suitable polyfunctional regulators are Si compounds of the formula (IVb). 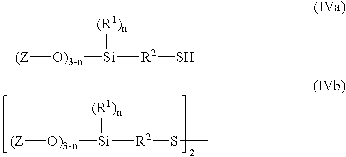
in which
n is a value from 0 to 2,
R¹ is a C₁-C₁₆-alkyl group or phenyl group
R² is a C₁-C₁₈-alkyl group, the cyclohexyl or phenyl group,
Z is a C₁-C₁₈-alkyl group, C₂-C₁₈-alkylene group or C₂-C₁₈-alkynyl group whose carbon atoms may be replaced by nonadjacent oxygen or halogen atoms, or is one of the groups 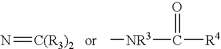
in which
R₃ is a C₁-C₁₂-alkyl group and
R₄ is a C₁-C₁₈-alkyl group.

Particular preference is given to compounds IVa, among these primarily mercaptopropyl-trimethoxysilane and mercaptopropyltriethoxysilane.

All said regulators may be used individually or in combination with one another.

In a preferred embodiment of the process, multifunctional regulators are used.

The invention further provides a process for the preparation of aqueous dispersions where a) at least one N-vinyl-containing monomer and/or at least one

a) (meth)acrylamide monomer

b) at least one polymeric dispersant

c) at least one polymeric precipitation agent

d) at least one crosslinker

e) optionally further monomers

g) optionally in the presence of a buffer substance

are reacted in the presence of at least one regulator and the weight ratio of b) to c) is in the range from 1:50 to 1:0.02.

Initiators which can be used for the free-radical polymerization may be water-soluble and water-insoluble peroxo and/or azo compounds, for example alkali metal or ammonium peroxydisulfates, hydrogen peroxide, dibenzoyl peroxide, tert-butyl perpivalate, 2,2′-azobis(2,4-dimethylvaleronitrile), tert-butyl peroxyneodecanoate, tert-butyl per-2-ethylhexanoate, di-tert-butyl peroxide, tert-butyl hydroperoxide, azobisisobutyronitrile, azobis(2-amidinopropane) dihydrochloride or 2,2′-azobis(2-methylbutyronitrile). Also suitable are initiator mixtures or redox initiator systems, such as, for example, ascorbic acid/iron(II) sulfate/sodium peroxodisulfate, tert-butyl hydroperoxide/sodium disulfite, tert-butyl hydroperoxide/sodium hydroxymethanesulfanate, hydrogen peroxide/ascorbic acid. The initiators can be used in the customary amounts, for example 0.05 to 7% by weight, based on the amount of the monomers to be polymerized.

Through the co-use of redox coinitiators, for example benzoin, dimethylaniline and organically soluble complexes and salts of heavy metals, such as copper, cobalt, manganese, nickel and chromium or, in particular, iron, the half-life times of said peroxides, particularly of the hydroperoxides, can be reduced, meaning that, for example, tert-butyl hydroperoxide is effective in the presence of 5 ppm of copper II acetylacetonate even at 100° C.

Preference is given to using water-soluble initiators, such as hydroperoxides, peroxides and/or hydrochlorides. The process is particularly preferably carried out with the initiators chosen from the group formed by hydrogen peroxide, tert-butyl hydroperoxide, azobis(2-amidinopropane) dihydrochloride and/or hydrogen peroxide/ascorbic acid.

In one embodiment of the invention, the process is carried out in the presence of a buffer g). Preferably, the polymerization is also pH-regulated through a metered/automated addition of acids or bases, as a result of which the preferred pH range can be maintained throughout the entire polymerization.

The polymerization reaction is started with the help of polymerization initiators which decompose into free radicals. It is possible to use all initiators which are known for the polymerization of the monomers. For example, initiators which decompose into free radicals and which have half-life times of less than 3 hours at the temperatures chosen in each case are suitable. If the polymerization is carried out at different temperatures by carrying out initial polymerization of the monomers firstly at a lower temperature and then completing the polymerization at a significantly higher temperature, then at least two different initiators are expediently used which have an adequate rate of decomposition in the temperature range chosen in each case.

The polymerization is usually carried out at temperatures between 20 and 200° C., preferably between 30 and 90° C., very preferably between 40 and 80° C., at atmospheric pressure or under intrinsic pressure. Preferably, the polymerization is under a nitrogen atmosphere, in particular at slightly increased pressure (e.g. set from 0.5 to 1 bar nitrogen overpressure prior to the start of polymerization at T=25° C.).

Customary processing auxiliaries, such as complexing agents (for example ethylenediamine-tetraacetic acid, EDTA), odorants, can be added where necessary. Viscosity modifiers, such as glycerol, methanol, ethanol, t-butanol, glycol, etc., can likewise be added to the aqueous dispersion.

The polymerization is carried out in a preferred embodiment as a batch procedure. In this connection, it is preferred to initially introduce components (a-g) into the vessel.

In a further preferred embodiment, the process according to the invention is carried out as a feed procedure. In this connection, individual or all reaction participants are added, completely or partially, in portions or continuously, together or in separate feeds, to the reaction mixture. It is, however, also possible to meter in the initiator to the initial charge heated to the polymerization temperature and comprising the polymeric dispersants, polymeric precipitation agent(s), and monomeric components (a), (d) and optionally monomer (e) and regulator (f) and buffer (g). In a further variant to a mixture of monomers (a) and (d) and optionally monomer (e) a solvent of the initiator and a solvent of the regulator (f) are continuously added after the polymerization temperature has been reached over a prolonged period to an initial charge comprising (g). It is also possible to heat the initial charge comprising the polymeric precipitation agents (c) and polymeric dispersants b) and monomer (d) and optionally buffer (g) to the polymerization temperature and to add the initiator solution and monomers (a) and optionally (e) in separate feeds.

It is of course also possible to add initiator, monomers d) and monomers a) and optionally monomers e) to an initial charge heated to the polymerization temperature and comprising a mixture of polymeric precipitation agents c) and polymeric dispersants b) and buffer g).

Preference is given to using a mixture of polymeric precipitation agents c) and polymeric dispersants b) in water and at least part of monomers a), d) and optionally e) and optionally regulator f) and optionally buffer g), and optionally further components as the initial charge.

The dispersions are usually milky white and generally have a viscosity of from 100 to 50 000 mPas, preferably from 200 to 20 000 mPas, particularly preferably from 300 to 15 000 mPas.

The dispersions produced in the polymerization can, after the polymerization process, be subjected to a physical or chemical after-treatment. Such processes are, for example, the known processes for reducing residual monomers, such as, for example, after-treatment by adding polymerization initiators or mixtures of two or more polymerization initiators at suitable temperatures or heating the polymerization solution to temperatures above the polymerization temperature, an after-treatment of the polymer solution by means of steam or stripping with nitrogen or treatment of the reaction mixture with oxidizing or reducing agents, adsorption processes, such as the absorption of contamination on selected media, such as, for example, activated carbon, or an ultrafiltration. The known work-up steps may also follow, for example suitable drying processes, such as spray-drying, freeze-drying or roll-drying, or agglomeration processes following the drying. The dispersions with a low content of residual monomers obtained by the process according to the invention can also be sold directly.

In a preferred embodiment, the aqueous dispersions are subjected to a treatment with the aim of converting the component (s) present in the polymer into the corresponding amine, so that the proportion of the resulting amines in the polymer is <20 mol %, preferably <15 mol %, in particular below 10 mol %, particularly preferably below 5 mol %, based on component (a). A suitable method which may be mentioned is hydrolysis.

Cleaving off formyl groups from polymers comprising N-vinylformamide units and cleaving off the CH₃—CO group from polymers comprising N-vinylacetamide units gives in each case polymers comprising vinylamine units. The cleavage may be carried out partially or completely. If the hydrolysis is carried out in the presence of acids, the vinylamine units of the polymers are in the form of ammonium salts. The hydrolysis can, however, also be carried out using bases, e.g. metal hydroxides, in particular alkali metal and alkaline earth metal hydroxides. Preference is given to using sodium hydroxide or potassium hydroxide. In special cases, the hydrolysis can also be carried out using ammonia or amines. In the case of hydrolysis in the presence of bases, the vinylamine units are in the form of the free bases.

Suitable hydrolyzing agents are preferably mineral acids, such as hydrogen halides, which can be used in gaseous form or in the form of an aqueous solution. Preference is given to using concentrated hydrochloric acid, sulfuric acid, nitric acid or phosphoric acid, and also organic acids, such as C₁- to C₅-carboxylic acids, and aliphatic or aromatic sulfonic acids. For example, per formyl group equivalent in the polymers comprising N-vinylformamide units in copolymerized form, 0.05 to 2 mol equivalents, in particular 1 to 1.5 mol equivalents, of an acid are required. The hydrolysis of the N-vinylformamide units proceeds significantly more rapidly than that of the polymers having N-vinylacetamide units. If copolymers of the suitable vinylcarboxamides are subjected to the hydrolysis with other comonomers, then the comonomer units present in the copolymer may also be chemically changed. Thus, for example, vinyl acetate units produce vinyl alcohol units. During the hydrolysis, methyl acrylate units give acrylic acid units, and acrylonitrile units form acrylamide or acrylic acid units. The hydrolysis of the N-vinylformamide and/or vinylacetamide units of polymers (A) can be carried out up to 5 to 100%, preferably 10 to 40%. Although the aqueous dispersions of water-soluble N-vinylcarboxamides go into solution upon dilution with water, the dispersion is surprisingly not destroyed during hydrolysis. For the uses according to the invention given below, besides the dispersions according to the invention, it is also possible to use those aqueous dispersions which are obtainable by free-radical polymerization of

a) at least one (meth)acrylamide monomer and optionally an N-vinyl-containing monomer

b) at least one polymeric dispersant

c) at least one polymeric precipitation agent

e) optionally further monomers

f) optionally at least one regulator

g) optionally in the presence of a buffer substance

where the weight ratio of b) to c) is in the range from 1:50 to 1:0.02.

In these dispersions likewise suited for the use according to the invention, the monomers a) and e), the polymeric dispersants b), the polymeric precipitation agents c), the regulators f) and the buffer substances g), and the respective quantitative ratios correspond to the definitions as described above.

For example, the dispersions according to the invention are used in cosmetic compositions for cleansing the skin. Such cosmetic cleansing compositions are chosen from bar soaps, such as toilet soaps, curd soaps, transparent soaps, luxury soaps, deodorizing soaps, cream soaps, baby soaps, skin protection soaps, abrasive soaps and syndets, liquid soaps, such as pasty soaps, soft soaps and washing pastes, and liquid washing, shower and bath preparations, such as washing lotions, shower preparations and shower gels, foam baths, oil baths and scrub preparations.

Preferably, the dispersions according to the invention are used in cosmetic compositions for the care and protection of the skin, in nail care compositions and in preparations for decorative cosmetics.

Particular preference is given to the use in skincare compositions, personal hygiene compositions, footcare compositions, deodorants, light protection compositions, repellents, shaving compositions, hair-removal compositions, antiacne compositions, make-up, mascara, lipsticks, eyeshadows, kohl pencils, eyeliners, blushers, powders and eyebrow pencils.

The skincare compositions are in particular in the form of W/O or O/W skin creams, day and night creams, eye creams, face creams, antiwrinkle creams, moisturizing creams, bleaching creams, vitamin creams, skin lotions, care lotions and moisturizing lotions.

The dispersions according to the invention can develop particular effects in the cosmetic preparations. The dispersions can, inter alia, contribute to the moisturization and conditioning of the skin and to the improvement in the feel of the skin. The dispersions can also act as thickeners in the formulations. The addition of the dispersions according to the invention can, in certain formulations, bring about a considerable improvement in the skin compatibility.

The dispersions according to the invention are present in the skin cosmetic preparations in an amount of from about 0.001 to 20% by weight, preferably 0.01 to 10% by weight, very particularly preferably 0.1 to 5% by weight, based on the total weight of the composition.

Depending on the field of use, the compositions according to the invention can be applied in a form suitable for skincare, such as, for example, in the form of a cream, foam, gel, stick, powder, mousse, milk or lotion.

As well as the dispersions according to the invention and suitable solvents, the skin cosmetic preparations can also comprise additives customary in cosmetics, such as emulsifiers, preservatives, perfume oils, cosmetic active ingredients, such as phytantriol, vitamin A, E and C, retinol, bisabolol, panthenol, light protection agents, bleaching agents, colorants, tinting agents, tanning agents (e.g. dihydroxyacetone), collagen, protein hydrolysates, stabilizers, pH regulators, dyes, salts, thickeners, gel formers, bodying agents, silicones, humectants, refatting agents and further customary additives.

Suitable solvents which may be mentioned are, in particular, water and lower monoalcohols or polyols having 1 to 6 carbon atoms or mixtures thereof; preferred monoalcohols or polyols are ethanol, isopropanol, propylene glycol, glycerol and sorbitol.

As further customary additives, fatty bodies may be present, such as mineral and synthetic oils, such as, for example, paraffins, silicone oils and aliphatic hydrocarbons having more than 8 carbon atoms, animal and vegetable oils, such as, for example, sunflower oil, coconut oil, avocado oil, olive oil, lanolin, or waxes, fatty acids, fatty acid esters, such as, for example, triglycerides of C₆-C₃₀-fatty acids, wax esters, such as, for example, jojoba oil, fatty alcohols, vaseline, hydrogenated lanolin and acetylated lanolin. It is of course also possible to use mixtures thereof.

Customary thickeners in such formulations are crosslinked polyacrylic acids and derivatives thereof, polysaccharides, such as xanthan gum, agar agar, alginates or tyloses, carboxymethylcellulose or hydroxycarboxymethylcellulose, fatty alcohols, monoglycerides and fatty acids, polyvinyl alcohol and polyvinylpyrrolidone.

The dispersions according to the invention can also be mixed with customary polymers if specific properties are to be set.

Examples of suitable conventional polymers are anionic, cationic, amphoteric and neutral polymers.

Examples of anionic polymers are homopolymers and copolymers of acrylic acid and methacrylic acid or salts thereof, copolymers of acrylic acid and acrylamide and salts thereof; sodium salts of polyhydroxycarboxylic acids, water-soluble or water-dispersible polyesters, polyurethanes and polyureas. Particularly suitable polymers are copolymers of t-butyl acrylate, ethyl acrylate, methacrylic acid (e.g. Luvimer™ 100P), copolymers of ethyl acrylate and methacrylic acid (e.g. Luvimer™ MAE), copolymers of N-tert-butylacrylamide, ethyl acrylate, acrylic acid (Ultrahold™ 8, strong), copolymers of vinyl acetate, crotonic acid and optionally further vinyl esters (e.g. Luviset™ grades), maleic anhydride copolymers, optionally reacted with alcohols, anionic polysiloxanes, e.g. carboxyfunctional, copolymers of vinylpyrrolidone, t-butyl acrylate, methacrylic acid (e.g Luviskol™ VBM), copolymers of acrylic acid and methacrylic acid with hydrophobic monomers, such as, for example, C₄-C₃₀-alkyl esters of meth(acrylic acid), C₄-C₃₀-alkylvinyl esters, C₄-C₃₀-alkylvinyl ethers and hyaluronic acid. Luviset P.U.R., Luviflex Silk.

Further suitable polymers are cationic polymers with the INCI name Polyquaternium, e.g. copolymers of vinylpyrrolidone/N-vinylimidazolium salts (Luviquat™ FC, Luviquat™ HM, Luviquat™ MS, Luviquat™ Care, Luviquat™ Hold, INCI Polyquaternium-16, 44, 46), copolymers of acrylamide and dimethyldiallylammonium chloride (Polyquaternium-7), cationic cellulose derivatives (Polyquaternium-4, -10), cationic starch derivatives (INCI: Starch Hydroxypropytrimonium Chloride, Corn Starch Modified), cationic guar derivatives (INCI: Hydroxypropyl Guar Hydroxypropyltrimonium Chloride), cationic sunflower oil derivatives (INCI: Sunflowerseedamidopropyl Hydroxyethyldimonium Chloride), copolymers of N-vinypyrrolidone/dimethylaminoethyl methacrylate, quaternized with diethyl sulfate (Polyquaternium-11), copolymers of acrylic acid, acrylamide and methacrylamidopropyl-trimonium chloride (Polyquaternium-53), Polyquaternium-32, Polyquaternium-28 and others.

Suitable further polymers are also neutral polymers, such as polyvinylpyrrolidones, copolymers of N-vinylpyrrolidone and vinyl acetate and/or vinyl propionate, copolymers of N-vinypyrrolidone/dimethylaminopropylacrylamide or -methacrylamide, copolymers of N-vinylpyrrolidone and alkyl acrylate or methacrylate monomers with alkyl chains of from C1 to C18, graft copolymers of polyvinyl alcohol onto polyalkylene glycols, such as, for example, Kollicoat IR (BASF), graft copolymers of other vinyl monomers onto polyalkylene glycols, polysiloxanes, polyvinylcaprolactam and copolymers with N-vinylpyrrolidone, polyethyleneimines and salts thereof, polyvinylamines and salts thereof, cellulose derivatives, chitosan, polyaspartic acid salts and derivatives.

To set certain properties, the preparations can additionally also comprise conditioning substances based on silicone compounds. Suitable silicone compounds are, for example, polyalkylsiloxanes, polyarylsiloxanes, polyarylalkylsiloxanes, polyethersiioxanes, silicone resins, dimethicones, dimethicone derivatives or dimethicone copolyols (CTFA) and aminofunctional silicone compounds such as Amodimethicone (CTFA).

The dispersions according to the invention are used in cosmetic preparations whose preparation takes place in accordance with rules known to the person skilled in the art.

Such formulations are advantageously in the form of emulsions, preferably in the form of water-in-oil (W/O) or oil-in-water (O/W) emulsions. It is, however, also possible and in some cases advantageous according to the invention to choose other types of formulation, for example hydrodispersions, gels, oils, oleogels, multiple emulsions, for example in the form of W/O/W or O/W/O emulsions, anhydrous ointments or ointment bases etc.

The emulsions which can be used according to the invention are prepared by known methods.

As well as the dispersion according to the invention, the emulsions comprise customary constituents, such as fatty alcohols, fatty acid esters and, in particular, fatty acid triglycerides, fatty acids, lanolin and derivatives thereof, natural or synthetic oils or waxes and emulsifiers in the presence of water.

The selection of additives specific to the type of emulsion and the preparation of suitable emulsions is described, for example, in Schrader, Grundlagen und Rezepturen der Kosmetika [Fundamentals and Formulations of Cosmetics], Hüthig Buch Verlag, Heidelberg, 2nd edition, 1989, third part, to which express reference is hereby made.

Thus, a skin cream which can be used according to the invention can be in the form, for example, of a W/O emulsion. An emulsion of this type comprises an aqueous phase which is emulsified in an oil or fatty phase by means of a suitable emulsifier system.

The concentration of the emulsifier system in this type of emulsions is about 4 to 35% by weight, based on the total weight of the emulsion; the fatty phase constitutes about 20 to 60% by weight and the aqueous phase about 20 to 70% by weight, in each case based on the total weight of the emulsion. The emulsifiers are those which are customarily used in this type of emulsion. They are chosen, for example, from: C₁₂-C₁₈-sorbitan fatty acid esters; esters of hydroxystearic acid and C₁₂-C₃₀-fatty alcohols; mono- and diesters of C₁₂-C₁₈-fatty acids and glycerol or polyglycerol; condensates of ethylene oxide and propylene glycols; oxypropylenatedloxyethylenated C₁₂-C₂₀-fatty alcohols; polycyclic alcohols, such as sterols; aliphatic alcohols with a high molecular weight, such as lanolin; mixtures of oxypropylenated/polyglycerolated alcohols and magnesium isostearate; succinic esters of polyoxyethylenated or polyoxypropylenated fatty alcohols; and mixtures of magnesium, calcium, lithium, zinc or aluminum lanolate and hydrogenated lanolin or lanolin alcohol.

Suitable fatty components which may be present in the fatty phase of the emulsions include hydrocarbon oils, such as paraffin oil, purcellin oil, perhydrosqualene and solutions of microcrystalline waxes in these oils; animal or vegetable oils, such as sweet almond oil, avocado oil, calophylum oil, lanolin and derivatives thereof, castor oil, sesame oil, olive oil, jojoba oil, karité oil, hoplostethus oil; mineral oils whose distillation start point under atmospheric pressure is at about 250° C. and whose distillation end point is at 410° C., such as, for example, vaseline oil; esters of saturated or unsaturated fatty acids, such as alkyl myristates, e.g. isopropyl, butyl or cetyl myristate, hexadecyl stearate, ethyl or isopropyl palmitate, octanoic or decanoic acid triglycerides and cetyl ricinoleate.

The fatty phase may also comprise silicone oils soluble in other oils, such as dimethylpolysiloxane, methylphenylpolysiloxane and the silicone glycol copolymer, fatty acids and fatty alcohols.

In order to favor the retention of oils, it is also possible to use waxes, such as, for example, carnauba wax, candellila wax, beeswax, microcrystalline wax, ozokerite wax and Ca, Mg and Al oleates, myristates, linoleates and stearates.

In general, these water-in-oil emulsions are prepared by adding the fatty phase and the emulsifier to the batch container. The latter is heated at a temperature of from 70 to 75° C., then the oil-soluble ingredients are added, and water which has been heated beforehand to the same temperature and in which the water-soluble ingredients have been dissolved beforehand is added; the mixture is stirred until an emulsion of the desired fineness is achieved, which is then left to cool to room temperature, if necessary with a lesser amount of stirring.

In addition, a care emulsion according to the invention may be in the form of a O/W emulsion. Such an emulsion usually comprises an oil phase, emulsifiers which stabilize the oil phase in the water phase, and an aqueous phase which is usually present in thickened form.

The aqueous phase of the O/W emulsion of the preparations according to the invention optionally comprises

alcohols, diols or polyols and esters thereof, preferably ethanol, isopropanol, propylene glycol, glycerol, ethylene glycol monoethyl ether;

customary thickeners or gel formers, such as, for example, crosslinked polyacrylic acids and derivatives thereof, polysaccharides, such as xanthan gum or alginates, carboxymethylcellulose or hydroxycarboxymethylcellulose, fatty alcohols, polyvinyl alcohol and polyvinylpyrrolidone.

The oil phase comprises oil components customary in cosmetics, such as, for example:

esters of saturated and/or unsaturated, branched and/or unbranched C₃-C₃₀-alkanecarboxylic acids and saturated and/or unsaturated, branched and/or unbranched C₃-C₃₀-alcohols, of aromatic carboxylic acids and saturated and/or unsaturated, branched and/or unbranched C₃-C₃₀-alcohols, for example isopropyl myristate, isopropyl stearate, hexyldecyl stearate, oleyl oleate; and also synthetic, semisynthetic and natural mixtures of such esteres, such as jojoba oil;

branched and/or unbranched hydrocarbons and hydrocarbon waxes;

silicone oils, such as cyclomethicone, dimethylpolysiloxane, diethylpolysiloxane, octamethylcyclotetrasiloxane and mixtures thereof;

dialkyl ethers;

mineral oils and mineral waxes;

triglycerides of saturated and/or unsaturated, branched and/or unbranched C₈-C₂₄-alkane-carboxylic acids; they can be chosen from synthetic, semisynthetic or natural oils, such as olive oil, palm oil, almond oil or mixtures.

Suitable emulsifiers are, preferably O/W emulsifiers, such as polyglycerol esters, sorbitan esters or partially esterified glycerides.

The preparation may be carried out by melting the oil phase at about 80° C.; the water-soluble constituents are dissolved in hot water, added to the oil phase slowly and with stirring; homogenized and stirred until cold.

The dispersions according to the invention are also suitable for use in washing and shower gel formulations and bath preparations.

As well as the dispersions according to the invention, such formulations usually comprise anionic surfactants as base surfactants and amphoteric and nonionic surfactants as cosurfactants, and also lipids, perfume oils, dyes, organic acids, preservatives and antioxidants, and thickeners/gel formers, skin conditioning agents and humectants.

In the washing, showering and bath preparations, all anionic, neutral, amphoteric or cationic surfactants customarily used in body-cleansing compositions may be used.

The formulations comprise 2 to 50% by weight of surfactants, preferably 5 to 40% by weight, particularly preferably 8 to 30% by weight.

Suitable anionic surfactants are, for example, alkyl sulfates, alkyl ether sulfates, alkylsulfonates, alkylarylsulfonates, alkyl succinates, alkyl sulfosuccinates, N-alkoylsarcosinates, alkyl glycol alkoxylates, acyl taurates, acyl isethionates, alkyl phosphates, alkyl ether phosphates, alkyl ether carboxylates, alpha-olefinsulfonates, in particular the alkali metal and alkaline earth metal salts, e.g. sodium, potassium, magnesium, calcium, and ammonium and triethanolamine salts. The alkyl ether sulfates, alkyl ether phosphates and alkyl ether carboxylates can have between 1 and 10 ethylene oxide or propylene oxide units, preferably 1 to 3 ethylene oxide units, in the molecule.

Suitable compounds are, for example, sodium lauryl sulfate, ammonium lauryl sulfate, sodium lauryl ether sulfate, ammonium lauryl ether sulfate, sodium lauryl sarcosinate, sodium oleyl succinate, ammonium lauryl sulfosuccinate, sodium dodecylbenzenesulfonate, triethanolamine dodecylbenzenesulfonate.

Suitable amphoteric surfactants are, for example, alkylbetaines, alkylamidopropylbetaines, alkylsulfobetaines, alkyl glycinates, alkyl carboxyglycinates, alkyl amphoacetates or amphopropionates, alkyl amphodiacetates or amophodipropionates.

For example, it is possible to use cocodimethylsulfopropylbetaine, laurylbetaine, cocamidopropylbetaine or sodium cocamphopropionate.

Suitable nonionic surfactants are, for example, the reaction products of aliphatic alcohols or alkylphenols, having 6 to 20 carbon atoms in the alkyl chain, which may be linear or branched, with ethylene oxide and/or propylene oxide. The amount of alkylene oxide is about 6 to 60 mol per mole of alcohol. Also suitable are alkylamine oxides, mono- or dialkylalkanolamides, fatty acid esters of polyethylene glycols, ethoxylated fatty acid amides, alkyl polyglycosides or sorbitan ether esters.

In addition, the washing, shower and bath preparations can comprise customary cationic surfactants, such as, for example, quaternary ammonium compounds, for example cetyltrimethylammonium chloride or bromide (INCI Cetrimonium chloride or bromide), hydroxyethylcetyidimonium phosphate (INCI Quaternium-44), INCI cocotrimonium methosulfate, INCI Quaternium-52.

Additionally, further customary cationic polymers may also be used, such as, for example, copolymers of acrylamide and dimethyldiallylammonium chloride (Polyquaternium-7), cationic cellulose derivatives (Polyquaternium-4, -10), cationic starch derivatives (INCI: Starch Hydroxypropytrimonium Chloride, Corn Starch Modified), cationic guar derivatives (INCI: Hydroxypropyl Guar Hydroxypropyltrimonium Chloride), cationic sunflower oil derivatives (INCI: Sunflowerseedamidopropyl Hydroxyethyldimonium Chloride), copolymers of N-vinylpyrrolidone and quaternized N-vinylimidazole (Polyquaternium-16, -44, -46), copolymers of N-vinylpyrrolidone/dimethylaminoethyl methacrylate, quaternized with diethyl sulfate (Polyquaternium-11), copolymers of acrylic acid, acrylamide and methacrylamidopropyl-trimonium chloride (Polyquaternium-53), Polyquaternium-32, Polyquaternium-28 and others.

In addition, the washing and shower gel formulations and bath preparations can comprise thickeners, such as, for example, sodium chloride, PEG-55, propylene glycol oleate, PEG-120 methyl glucose dioleate and others, and also preservatives, further active ingredients and auxiliaries and water.

Hair cosmetic preparations include, in particular styling compositions and/or conditioning agents in hair cosmetic preparations, such as hair treatments, hair mousses, hair gels or hair sprays, hair lotions, hair rinses, hair shampoos, hair emulsions, hair-end fluids, neutralizers for permanent waves, hair colorants and bleaches, hot-oil treatment preparations, conditioners, setting lotions or hair sprays. Depending on the field of application, the hair cosmetic preparations can be applied in the form of (aerosol) spray, (aerosol) mousse, gel, gel spray, cream, lotion or wax.

In a preferred embodiment, the hair cosmetic formulations according to the invention comprise

a) 0.05 to 20% by weight of the dispersion according to the invention

b) 20 to 99.95% by weight of water and/or alcohol

c) 0 to 79.5% by weight of further constituents

Alcohol is understood as meaning all alcohols customary in cosmetics, e.g. ethanol, isopropanol, n-propanol.

Further constituents are understood as meaning the additives customary in cosmetics, for example propellants, antifoams, interface-active compounds, i.e. surfactants, emulsifiers, foam formers and solubilizers. The interface-active compounds used may be anionic, cationic, amphoteric or neutral. Further customary constituents may also be, for example, preservatives, perfume oil, emollients, effect substances, opacifiers, active ingredients, antioxidants, peroxide decomposers, UV filters, care substances, such as panthenol, collagen, vitamins, protein hydrolysates, alpha- and beta-hydroxycarboxylic acids, protein hydrolysates, stabilizers, pH regulators, dyes, pigments, viscosity regulators, gelling agents, salts, humectants, refatting agents, complexing agents and further customary additives.

Also included here are all styling and conditioning polymers known in cosmetics which can be used in combination with the polymers according to the invention if very specific properties are to be set.

Examples of suitable conventional hair cosmetic polymers are anionic polymers. Such anionic polymers are homopolymers and copolymers of acrylic acid and methacrylic acid or salts thereof, copolymers of acrylic acid and acrylamide and salts thereof; sodium salts of polyhydroxycarboxylic acids, water-soluble or water-dispersible polyesters, polyurethanes (Luviset™ P.U.R.) and polyureas. Particularly suitable polymers are copolymers of t-butyl acrylate, ethyl acrylate, methacrylic acid (e.g. Luvimer™ 100P), copolymers of N-tert-butylacrylamide, ethyl acrylate, acrylic acid (e.g. Ultrahold™ 8, strong), copolymers of vinyl acetate, crotonic acid and optionally further vinyl esters (e.g. Luviset™ grades, INCI: VA/Crotonates Copolymer), maleic anhydride copolymers, optionally reacted with alcohols, anionic polysiloxanes, e.g. carboxyfunctional ones, copolymers of vinylpyrrolidone, t-butyl acrylate, methacrylic acid (e.g. Luviskol™ VBM).

In addition, the group of polymers suitable for the combination with the polymers according to the invention includes, by way of example, Balance CR or 0/55 (national starch; acrylate copolymer), Balance 47 (national starch; octylacrylamide/acrylate/butylaminoethyl methacrylate copolymer), Aquaflex™ FX 64 (ISP; isobutylene/ethylmaleimide/hydroxyethylmaleimide copolymer), Aquaflex™ SF40 (ISP/national starch; VP/vinyl caprolactam/DMAPA acrylate copolymer), Allianz™ LT-120 (ISP/Rohm & Haas; acrylate/C1-2 succinate/hydroxyacrylate copolymer), Aquarez™ HS (Eastman; polyester-1), Diaformer™ Z-400 (Clariant; methacryloylethylbetaine/methacrylate copolymer), Diaformer™ Z-711 or Z-712 (Clariant; methacryloylethyl N-oxide/methacrylate copolymer), Omnirez™ 2000 (ISP; monoethyl ester of poly(methyl vinyl ether/maleic acid in ethanol), Amphomer™ HC or Resyn XP or Resyn 28-4961 (national starch; acrylate/octylacrylamide copolymer), Amphomer™ 28-4910 (national starch; octylacrylamide/acrylate/butylaminoethyl methacrylate copolymer), Advantage™ HC 37 (ISP; terpolymer of vinylcaprolactam/vinylpyrrolidone/dimethylaminoethyl methacrylate), Advantage grades (ISP), Acudyne 258 (Rohm & Haas; acrylate/hydroxy ester acrylate copolymer), Luviset™ P.U.R. (BASF, polyurethane-1), Luviflex™ Silk (BASF, PEG/PPG-25/25 dimethicone/acrylates copolymer), Eastman™ AQ48 (Eastman), Styleze 2000 (ISP; VP/acrylates/lauryl methacrylate copolymer), Styleze CC-10 (ISP; VP/DMAPA acrylates copolymer), Styleze W-20 (ISP), Fixomer A-30 (Ondeo Nalco; methacrylic acid/sodium acrylamidomethylpropanesulfonate copolymer), Fixate G-100 (Noveon; AMP acrylates/allyl methacrylate copolymer).

Very particularly preferred anionic polymers are acrylates with an acid number greater than or equal to 120 and copolymers of t-butyl acrylate, ethyl acrylate, methacrylic acid.

Further suitable hair cosmetic polymers are cationic polymers with the INCI name polyquaternium, e.g. copolymers of vinylpyrrolidone/N-vinylimidazolium salts (Luviquat™ FC, Luviquat™ HM, Luviquat™ MS, Luviquat™ Care, INCI: Polyquaternium-16, Polyquaternium-44), copolymers of N-vinylpyrrolidone/dimethylaminoethyl methacrylate, quaternized with diethyl sulfate (Luviquat™ PQ 11, INCI: Polyquaternium-11), copolymers of N-vinylcaprolactam N-vinylpyrrolidone/N-vinylimidazolium salts (Luviquat™ Hold, INCI: Polyquaternium-46); copolymers of acrylamide and dimethyldiallylammonium chloride (Polyquaternium-7), cationic cellulose derivatives (Polyquaternium-4, -10), cationic starch derivatives (INCI: Starch Hydroxypropytrimonium Chloride, Corn Starch Modified), cationic guar derivatives (INCI: Hydroxypropyl Guar Hydroxypropyltrimonium Chloride), cationic sunflower oil derivatives (INCI: Sunflowerseedamidopropyl Hydroxyethyldimonium Chloride), copolymers of acrylic acid, acrylamide and methacrylamidopropyltrimonium chloride (INCI: Polyquaternium-53), Polyquaternium-32, Polyquaternium-28 and others.

Further suitable hair cosmetic polymers are also neutral polymers, such as polyvinylpyrrolidones, copolymers of N-vinylpyrrolidone and vinyl acetate and/or vinyl propionate, copolymers of N-vinypyrrolidone/dimethylaminopropylacrylamide or -methacrylamide, copolymers of N-vinylpyrrolidone and alkyl acrylate or alkyl methacrylate monomers with alkyl chains of from C1 to C18, graft copolymers of polyvinyl alcohol onto polyalkylene glycols, such as, for example Kollicoat IR (BASF), graft copolymers of other vinyl monomers onto polyalkylene glycols, polysiloxanes, polyvinylcaprolactam and copolymers containing N-vinylpyrrolidone, polyethyleneimines and salts thereof, polyvinylamines and salts thereof, cellulose derivatives, chitosan, polyaspartic acid salts and derivatives.

To set certain properties, the preparations may additionally also comprise conditioning substances based on silicone compounds. Suitable silicone compounds are, for example, polyalkylsiloxanes, polyarylsiloxanes, polyarylalkylsiloxanes, polyether siloxanes, silicone resins, dimethicones, dimethicone derivatives or dimethicone copolyols (CTFA) and aminofunctional silicone compounds such as amodimethicones (CTFA).

The polymers according to the invention are particularly suitable as setting agents in hair styling preparations, in particular hair sprays (aerosol sprays and pump sprays without propellant gas) and hair mousses (aerosol mousses and pump mousses without propellant gas).

In a preferred embodiment, these preparations comprise

a) 0.1 to 10% by weight of the dispersion according to the invention

b) 20 to 99.9% by weight of water and/or alcohol

c) 0 to 70% by weight of a propellant

d) 0 to 20% by weight of further constituents

Propellants are the propellants customarily used for hair sprays or aerosol mousses. Preference is given to mixtures of propane/butane, pentane, dimethyl ether, 1,1-difluoroethane (HFC-152 a), carbon dioxide, nitrogen or compressed air.

A formulation for aerosol hair mousses which is preferred according to the invention comprises

a) 0.1 to 10% by weight of the dispersion according to the invention

b) 55 to 99.8% by weight of water and/or alcohol

c) 5 to 20% by weight of a propellant

d) 0.1 to 5% by weight of an emulsifier

e) 0 to 10% by weight of further constituents

The emulsifiers used may be emulsifiers customarily used in hair mousses. Suitable emulsifiers may be nonionic, cationic or anionic or amphoteric.

Examples of nonionic emulsifiers (INCI nomenclature) are laureths, e.g. laureth-4; ceteths, e.g. cetheth-1, polyethylene glycol cetyl ether; ceteareths, e.g. cetheareth-25, polyglycol fatty acid glycerides, hydroxylated lecithin, lactyl esters of fatty acids, alkyl polyglycosides.

Examples of cationic emulsifiers are cetyltrimethylamonium chloride or bromide (INCI cetrimonium chloride or bromide), hydroxyethylcetyidimonium phosphate (INCI Quaternium-44), INCI cocotrimonium methosulfate, INCI Quaternium-52, Quaternium-1 to x (INCI).

Anionic emulsifiers may be chosen, for example, from the group of alkyl sulfates, alkyl ether sulfates, alkylsulfonates, alkylarylsulfonates, alkylsuccinates, alkylsulfosuccinates, N-alkoylsarcosinates, alkyl glycol alkoxylates, acyltaurates, acyl isethionates, alkyl phosphates, alkyl ether phosphates, alkyl ether carboxylates, alpha-olefinsulfonates, in particular the alkali metal and alkaline earth metal salts, e.g. sodium, potassium, magnesium, calcium, and ammonium and triethanolamine salts. The alkyl ether sulfates, alkyl ether phosphates and alkyl ether carboxylates can have between 1 and 10 ethylene oxide or propylene oxide units, preferably 1 to 3 ethylene oxide units, in the molecule.

Examples of hair mousses see examples for cosmetic formulations from 38 to 43.

A preparation which is suitable according to the invention for styling gels may, for example, have the following composition:

a) 0.1 to 10% by weight of the dispersion according to the invention

b) 60 to 99.85% by weight of water and/or alcohol

c) 0.05 to 10% by weight of a gelling agent

d) 0 to 20% by weight of further constituents

Gelling agents which may be used are all gelling agents customary in cosmetics. These include slightly crosslinked polyacrylic acid, for example Carbomer (INCI), cellulose derivatives, e.g. hydroxypropylcellulose, hydroxyethylcellulose, cationically modified celluloses, polysaccharides, e.g. xanthan gum, caprylic/capric triglycerides, sodium acrylates copolymer, polyquaternium-32 (and) paraffinum liquidum (INCI), sodium acrylates copolymer (and) paraffinum liquidum (and) PPG-1 trideceth-6, acrylamidopropyl trimonium chloride/acrylamide copolymer, steareth-10 allyl ether acrylates copolymer, polyquaternium-37 (and) paraffinum liquidum (and) PPG-1 trideceth-6, polyquaternium 37 (and) propylene glycol dicaprate dicaprylate (and) PPG-1 trideceth-6, polyquaternium-7, polyquaternium-44.

Examples of styling gels are given for the examples for cosmetic preparations from 44 to 52.

The dispersions according to the invention can be used in cosmetic preparations as conditioning agents. Examples of rinse-off and leave-on conditioners are numbers 53 to 55.

The dispersions according to the invention can be used in cosmetic preparations as thickeners.

The invention also provides methods of increasing the viscosity of a preparation by adding the dispersion according to the invention or an aqueous dispersion obtainable by free-radical polymerization of

a) at least one (meth)acrylamide monomer and optionally at least one N-vinyl-containing monomer

b) at least one polymeric dispersant

c) at least one polymeric precipitation agent

e) optionally further monomers

f) optionally at least one regulator

g) optionally in the presence of a buffer substance

where the weight ratio of b) to c) is in the range from 1:50 to 1:0.02 and where the at least one monomer a), the polymeric dispersant b), the polymeric precipitation reagent c), the further monomer e), the regulator f), and the buffer substance g) are as defined above.

The dispersions according to the invention can also be used in shampoo formulations as setting agents and/or conditioning agents. Suitable conditioning agents are, in particular, polymers with a cationic charge. Preferred shampoo formulations comprise

a) 0.05 to 10% by weight of the dispersion according to the invention

b) 25 to 94.95% by weight of water

c) 5-50% by weight of surfactant

c) 0-5% by weight of a further conditioning agent

d) 0-10% by weight of further cosmetic constituents

In the shampoo formulations, it is also possible to use all anionic, neutral, amphoteric or cationic surfactants customarily used in shampoos.

Suitable anionic surfactants are, for example, alkyl sulfates, alkyl ether sulfates, alkylsulfonates, alkylarylsulfonates, alkyl succinates, alkyl sulfosuccinates, N-alkoylsarcosinates, acyl taurates, acyl isethionates, alkyl glycol alkoxylates, alkyl phosphates, alkyl ether phosphates, alkyl ether carboxylates, alpha-olefinsulfonates, in particular the alkali metal and alkaline earth metal salts, e.g. sodium, potassium, magnesium, calcium, and ammonium and triethanolamin salts. The alkyl ether sulfates, alkyl ether phosphates and alkyl ether carboxylates can have between 1 and 10 ethylene oxide or propylene oxide units, preferably 1 to 3 ethylene oxide units, in the molecule.

Suitable examples are sodium lauryl sulfate, ammonium lauryl sulfate, sodium lauryl ether sulfate, ammonium lauryl ether sulfate, sodium lauryl sarcosinate, sodium oleyl succinate, ammonium lauryl sulfosuccinate, sodium dodecylbenzenesulfonate, triethanolamine dodecylbenzenesulfonate.

Suitable amphoteric surfactants are, for example, alkylbetaines, alkylamidopropylbetaines, alkylsulfobetaines, alkyl glycinates, alkyl carboxyglycinates, alkyl amphoacetates or amphopropionates, alkyl amphodiacetates or amphodipropionates.

For example, it is possible to use cocodimethylsulfopropylbetaine, laurylbetaine, cocamidopropylbetaine or sodium cocamphopropionate.

Examples of suitable nonionic surfactants are the reaction products of aliphatic alcohols or alkylphenols having 6 to 20 carbon atoms in the alkyl chain, which may be linear or branched, with ethylene oxide and/or propylene oxide. The amount of alkylene oxide is about 6 to 60 mol per mole of alcohol. Also suitable are alkylamine oxides, mono- or dialkylalkanolamides, fatty acid esters of polyethylene glycols, alkyl polyglycosides or sorbitan ether esters.

Furthermore, the shampoo formulations may comprise customary cationic surfactants, such as, for example, quaternary ammonium compounds, for example cetyltrimethylammonium chloride or bromide (INCI cetrimonium chloride or bromide), hydroxyethylcetyidimonium phosphate (INCI Quaternium-44), INCI cocotrimonium methosulfate, INCI Quaternium-52.

In the shampoo formulations, to achieve certain effects, customary conditioning agents may be used in combination with the polymers according to the invention. These include, for example, cationic polymers with the INCI name Polyquaternium, e.g. copolymers of vinylpyrrolidone/N-vinylimidazolium salts (Luviquat™ FC, Luviquat™ HM, Luviquat™ MS, Luviquat™ Care, INCI: polyquaternium-16, polyquaternium-44), copolymers of N-vinylpyrrolidone/dimethylaminoethyl methacrylate, quaternized with diethyl sulfate (Luviquat™ PQ 11, INCI: Polyquaternium-11), copolymers of N-vinylcaprolactam N-vinylpyrrolidone/N-vinylimidazolium salts (Luviquat™ Hold, INCI: polyquaternium-46); copolymers of acrylamide and dimethyldiallylammonium chloride (Polyquaternium-7), cationic cellulose derivatives (Polyquaternium-4, -10). It is also possible to use cationic starch derivatives (INCI: Starch Hydroxypropytrimonium Chloride, Corn Starch Modified), cationic guar derivatives (INCI: Hydroxypropyl Guar Hydroxypropyltrimonium Chloride), cationic sunflower oil derivatives (INCI: Sunflowerseedamidopropyl Hydroxyethyldimonium Chloride), copolymers of acrylic acid, acrylamide and methacrylamidopropyltrimonium chloride (INCI: Polyquaternium-53), polyquaternium-32, polyquaternium-28 and others. It is also possible to use protein hydrolysates, and conditioning substances based on silicone compounds, for example polyalkylsiloxanes, polyarylsiloxanes, polyarylalkylsiloxanes, polyether siloxanes or silicone resins. Further suitable silicone compounds are dimethicone, dimethicone derivatives or dimethicone copolyols (CTFA) and aminofunctional silicone compounds such as amodimethicones (CTFA).

Examples of shampoo and shower gel formulations are given from numbers 59 to 68.

### PREPARATION EXAMPLES

### The Solids Content Given in All Examples is in % By Wt.

### Example 1

575.7 g of water, 2 g of sodium dihydrogenphosphate dihydrate, 6 g of polyvinylpyrrolidone (K value 90, determined with 1% strength aqueous solution), 10 g of polyvinylpyrrolidone (K value 17, determined with 1% strength aqueous solution) and 180 g of polyethylene glycol of molar mass 1500 were weighed into a 2 l glass vessel fitted with anchor stirrer (200 rpm) and nitrogen line, and processed to give a homogeneous solution by stirring. 180 g of N-vinylformamide, 44.4 g of N-vinyl-2-methylimmidazolium methylsulfate (45% aqueous solution), and 0.6 g of triallylamine were added and the pH of these solutions was then adjusted to 6.75 by adding 25% strength aqueous sodium hydroxide solution. Nitrogen was passed permanently through the reaction mixture and 1.0 g of 2,2′-azobis-2-(aminopropane) dihydrochloride (WakoV50) was added and the reaction mixture was heated to a temperature of 55° C. for the polymerization. The polymerization time was 4 hours. Subsequently, 0.24 g of 2,2′-azobis-2-(aminopropane) dihydrochloride (WakoVA44) was added and the mixture was polymerized for a further 2 hours at 65° C.

This gave an aqueous dispersion with a solids content of 39.9%, a viscosity of 650 mPas and an LD value (measured at 39.9% solids content) of <0.5%.

### Example 2

550.9 g of water, 2 g of sodium dihydrogenphosphate dihydrate, 6 g of polyvinylpyrrolidone (K value 90, determined with 1% strength aqueous solution), 10 g of polyvinylpyrrolidone (K value 17, determined with 1% strength aqueous solution) and 180 g of polyethylene glycol of molar mass 1500 were weighed into a 2 l glass vessel fitted with anchor stirrer (200 rpm) and nitrogen line, and processed to give a homogeneous solution by stirring. 180 g of N-vinylformamide, 88.9 g of N-vinyl-2-methylimmidazolium methylsulfate (45% aqueous solution), and 1.0 g of triallylamine were added and the pH of these solutions was then adjusted to 6.75 by adding 25% strength aqueous sodium hydroxide solution. Nitrogen was passed permanently through the reaction mixture and 1.0 g of 2,2′-azobis-2-(aminopropane) dihydrochloride (WakoV50) was added and the reaction mixture was heated to a temperature of 55° C. for the polymerization. The polymerization time was 4 hours. Subsequently, 0.24 g of 2,2′-azobis-2-(aminopropane) dihydrochloride (WakoVA44) was added and the mixture was polymerized for a further 2 hours at 65° C.

This gave an aqueous dispersion with a solids content of 39.9%, a viscosity of 5900 mPas and an LD value (measured at 39.9% solids content) of <0.5%.

### Example 3

575.7 g of water, 2 g of sodium dihydrogenphosphate dihydrate, 12 g of polyvinylpyrrolidone (K value 90, determined with 1% strength aqueous solution), 10 g of polyvinylpyrrolidone (K value 17, determined with 1% strength aqueous solution) and 180 g of polyethylene glycol of molar mass 1500 were weighed into a 2 l glass vessel fitted with anchor stirrer (200 rpm) and nitrogen line, and processed to give a homogeneous solution by stirring. 180 g of N-vinylformamide, 44.4 g of N-vinyl-2-methylimmidazolium methylsulfate (45% aqueous solution), and 0.4 g of triallylamine were added and the pH of these solutions was then adjusted to 6.75 by adding 25% strength aqueous sodium hydroxide solution. Nitrogen was passed permanently through the reaction mixture and 1.0 g of 2,2′-azobis-2-(aminopropane) dihydrochloride (WakoV50) was added and the reaction mixture was heated to a temperature of 55° C. for the polymerization. The polymerization time was 4 hours. Subsequently, 0.24 g of 2,2′-azobis-2-(aminopropane) dihydrochloride (WakoVA44) was added and the mixture was polymerized for a further 2 hours at 65° C.

This gave an aqueous dispersion with a solids content of 39.9%, a viscosity of 8600 mPas and an LD value (measured at 39.9% solids content) of <0.5%.

### Comparative Example 1 (C1)

775.7 g of water, 2 g of sodium dihydrogenphosphate dihydrate were weighed into a 2 l glass vessel fitted with anchor stirrer (200 rpm) and nitrogen line. 180 g of N-vinylformamide, 44.4 g of N-vinyl-2-methylimmidazolium methylsulfate (45% aqueous solution), and 0.6 g of triallylamine were added and the pH of the solution was then adjusted to 6.75 by adding 25% strength aqueous sodium hydroxide solution. Nitrogen was passed permanently through the reaction mixture and 1.0 g of 2,2′-azobis-2-(aminopropane) dihydrochloride (WakoV50) was added and the reaction mixture was heated to a temperature of 55° C. for the polymerization. The polymerization time was 4 hours. Subsequently, 0.24 g of 2,2′-azobis-2-(aminopropane) dihydrochloride (WakoVA44) was added and the mixture was polymerized for a further 2 hours at 65° C. This gave a solution with a solids content of 20.1%. The solution had a viscosity greater than 75 000 mPas and an LD value (measured at 20.1% solids content) of 95%.

### Comparative Example 2 (C2)

746.9 g of water, 2 g of sodium dihydrogenphosphate dihydrate were processed to give a homogeneous solution in a 2 l glass vessel fitted with anchor stirrer (200 rpm) and nitrogen line. 160 g of N-vinylformamide, 88.9 g of N-vinyl-2-methylimmidazolium methylsulfate (45% aqueous solution), and 1.0 g of triallylamine were added and the pH of the solution was then adjusted to 6.75 by adding 25% strength aqueous sodium hydroxide solution. Nitrogen was passed permanently through the reaction mixture and 1.0 g of 2,2′-azobis-2-(aminopropane) dihydrochloride (WakoV50) was added and the reaction mixture was heated to a temperature of 55° C. for the polymerization. The polymerization time was 4 hours. 0.24 g of 2,2′-azobis-2-(aminopropane) dihydrochloride (WakoVA44) was then added and the mixture was polymerized for a further 2 hours at 65° C. This gave an aqueous solution with a solids content of 20%. The aqueous solution had a viscosity greater than 75 000 mPas and an LD value (measured at 20% solids content) of 93%.

### Comparative Example 3 (C3)

575.7 g of water, 2 g of sodium dihydrogenphosphate dihydrate, 12 g of polyvinylpyrrolidone (K value 90, determined with 1% strength aqueous solution), 10 g of polyvinylpyrrolidone (K value 17, determined with 1% strength aqueous solution) and 180 g of polyethylene glycol of molar mass 1500 were weighed into a 2 l glass vessel fitted with anchor stirrer (200 rpm) and nitrogen line, and processed to give a homogeneous solution by stirring. 180 g of N-vinylformamide, 44.4 g of N-vinyl-2-methylimmidazolium methylsulfate (45% strength aqueous solution) were added and the pH of the solution was then adjusted to 6.75 by adding 25% strength aqueous sodium hydroxide solution. Nitrogen was passed permanently through the reaction mixture and 1.0 g of 2,2′-azobis-2-(aminopropane) dihydrochloride (WakoV50) was added and the reaction mixture was heated to a temperature of 55° C. for the polymerization. The polymerization time was 4 hours. 0.24 g of 2,2′-azobis-2-(aminopropane) dihydrochloride (WakoVA44) was then added and the mixture was polymerized for a further 2 hours at 65° C. This gave an aqueous dispersion with a solids content of 39.9%, a viscosity of 2600 mPas and an LD value (measured at 39.9% solids content) of 90%.

### Example 4

583 g of water, 2 g of sodium dihydrogenphosphate dihydrate, 6 g of polyvinylpyrrolidone (K value 90, determined with 1% strength aqueous solution), 6 g of polyvinylpyrrolidone (K value 17, determined with 1% strength aqueous solution) and 180 g of polyethylene glycol of molar mass 1500 were weighed into a 2 l glass vessel fitted with anchor stirrer (200 rpm) and nitrogen line, and processed to give a homogeneous solution by stirring. 160 g of N-vinylformamide, 61.5 g of diallyldimethylammonium chloride (65% strength aqueous solution), and 0.2 g of triallylamine were added and the pH of the solution was then adjusted to 6.75 by adding 25% strength aqueous sodium hydroxide solution. Nitrogen was passed permanently through the reaction mixture and 2.0 g of 2,2′-azobis-2-(aminopropane) dihydrochloride (WakoV50) was added and the reaction mixture was heated to a temperature of 55° C. for the polymerization. The polymerization time was 4 hours. 0.24 g of 2,2′-azobis-2-(aminopropane) dihydrochloride (WakoVA44) was then added and the mixture was polymerized for a further 4 hours at 65° C. This gave an aqueous dispersion with a solids content of 39.5%, a viscosity of 950 mPas and an LD value (measured at 39.5% solids content) of <0.5.

### Example 5

575.7 g of water, 2 g of sodium dihydrogenphosphate dihydrate, 6 g of polyvinylpyrrolidone (K value 90, determined with 1% strength aqueous solution), 10 g of polyvinylpyrrolidone (K value 17, determined with 1% strength aqueous solution) and 180 g of polyethylene glycol of molar mass 1500 were weighed into a 2 l glass vessel fitted with anchor stirrer (200 rpm) and nitrogen line, and processed to give a homogeneous solution by stirring. 180 g of N-vinylformamide, 44.4 g of N-vinyl-2-methylimmidazolium methylsulfate (45% strength aqueous solution), and 0.6 g of triallylamine were added and the pH of the solution was then adjusted to 6.75 by adding 25% strength aqueous sodium hydroxide solution. Nitrogen was passed permanently through the reaction mixture and 0.4 g of 2,2′-azobis-2-(aminopropane) dihydrochloride (WakoV50) was added and the reaction mixture was heated to a temperature of 50° C. for the polymerization. The polymerization time was 4 hours. 0.24 g of 2,2′-azobis-2-(aminopropane) dihydrochloride (WakoVA44) was then added and the mixture was polymerized for a further 2 hours at 65° C. This gave an aqueous dispersion with a solids content of 39.9%, a viscosity of 1100 mPas and an LD value (measured at 39.9% solids content) of <0.5%.

### Example 6

579.9 g of water, 2 g of sodium dihydrogenphosphate dihydrate, 6 g of polyvinylpyrrolidone (K value 90, determined with 1% strength aqueous solution), 6 g of polyvinylpyrrolidone (K value 17, determined with 1% strength aqueous solution) and 180 g of polyethylene glycol of molar mass 1500 were weighed into a 2 l glass vessel fitted with anchor stirrer (200 rpm) and nitrogen line, and processed to give a homogeneous solution by stirring. 140 g of N-vinylformamide, 40 g of vinylpyrrolidone, 44.4 g of N-vinyl-2-methylimmidazolium methylsulfate (45% strength aqueous solution), and 0.4 g of triallylamine were added and the pH of the solution was then adjusted to 6.75 by adding 25% strength aqueous sodium hydroxide solution. Nitrogen was passed permanently through the reaction mixture and 1.0 g of 2,2′-azobis-2-(aminopropane) dihydrochloride (WakoV50) was added and the reaction mixture was heated to a temperature of 55° C. for the polymerization. The polymerization time was 4 hours. 0.24 g of 2,2′-azobis-2-(aminopropane) dihydrochloride (WakoVA44) was then added and the mixture was polymerized for a further 2 hours at 65° C.

This gave an aqueous dispersion with a solids content of 39.9%, a viscosity of 1100 mPas and an LD value (measured at 39.9% solids content) of <0.5%.

### Example 7

583 g of water, 2 g of sodium dihydrogenphosphate dihydrate, 6 g of polyvinylpyrrolidone (K value 90, determined with 1% strength aqueous solution), 6 g of polyvinylpyrrolidone (K value 17, determined with 1% strength aqueous solution) and 180 g of polyethylene glycol of molar mass 1500 were weighed into a 2 l glass vessel fitted with anchor stirrer (200 rpm) and nitrogen line, and processed to give a homogeneous solution by stirring. 160 g of N-vinylformamide, 61.5 g of diallyidimethylammonium chloride (65% strength aqueous solution), and 0.2 g of triallylamine were added and the pH of the solution was then adjusted to 6.75 by adding 25% strength aqueous sodium hydroxide solution. Nitrogen was passed permanently through the reaction mixture and 1.5 g of 2,2′-azobis-2-(aminopropane) dihydrochloride (WakoV50) was added and the reaction mixture was heated to a temperature of 55° C. for the polymerization. The polymerization time was 4 hours. 0.24 g of 2,2′-azobis-2-(aminopropane) dihydrochloride (WakoVA44) was then added and the mixture was polymerized for a further 2 hours at 65° C.

This gave an aqueous dispersion with a solids content of 39.5%, a viscosity of 2100 mPas and an LD value (measured at 39.5% solids content) of <0.5%.

### Example 8

550.9 g of water, 2 g of sodium dihydrogenphosphate dihydrate, 6 g of polyvinylpyrrolidone (K value 90, determined with 1% strength aqueous solution), 10 g of Perfectamyl NR (cationic starch) and 180 g of polyethylene glycol of molar mass 1500 were weighed into a 2 l glass vessel fitted with anchor stirrer (200 rpm) and nitrogen line, and processed to give a homogeneous solution by stirring. 180 g of N-vinylformamide, 44.4 g of N-vinyl-2-methylimmidazolium methylsulfate (45% strength aqueous solution), and 0.6 g of triallylamine were added and the pH of the solution was then adjusted to 6.75 by adding 25% strength aqueous sodium hydroxide solution. Nitrogen was passed permanently through the reaction mixture and 1.0 g of 2,2′-azobis-2-(aminopropane) dihydrochloride (WakoV50) was added and the reaction mixture was heated to a temperature of 55° C. for the polymerization. The polymerization time was 4 hours. 0.24 g of 2,2′-azobis-2-(aminopropane) dihydrochloride (WakoVA44) was then added and the mixture was polymerized for a further 2 hours at 65° C.

This gave an aqueous dispersion with a solids content of 39.9%, a viscosity of 1900 mPas and an LD value (measured at 39.9% solids content) of <0.5.

### Example 9

550.9 g of water, 2 g of sodium dihydrogenphosphate dihydrate, 6 g of polyvinylpyrrolidone (K value 90, determined with 1% strength aqueous solution), 25 g of a 40% strength Luviquat FC 370 solution (copolymer of vinylpyrrolidone and vinyl-2-methylimidazolium methylsulfate: 7:3, K value about 40 determined using a 1% strength aqueous solution) and 180 g of polyethylene glycol of molar mass 1500 were weighed into a 2 l glass vessel fitted with anchor stirrer (200 rpm) and nitrogen line, and processed to give a homogeneous solution by stirring. 180 g of N-vinylformamide, 44.4 g of N-vinyl-2-methylimmidazolium methylsulfate (45% strength aqueous solution), and 0.6 g of triallylamine were added and the pH of the solution was then adjusted to 6.75 by adding 25% strength aqueous sodium hydroxide solution. Nitrogen was passed permanently through the reaction mixture and 1.0 g of 2,2′-azobis-2-(aminopropane) dihydrochloride (WakoV50) was added and the reaction mixture was heated to a temperature of 55° C. for the polymerization. The polymerization time was 4 hours. 0.24 g of 2,2′-azobis-2-(aminopropane) dihydrochloride (WakoVA44) was then added and the mixture was polymerized for a further 2 hours at 65° C.

This gave an aqueous dispersion with a solids content of 39.9%, a viscosity of 1450 mPas and an LD value (measured at 39.9% solids content) of <0.5.

### Example 10

550.9 g of water, 2 g of sodium dihydrogenphosphate dihydrate, 6 g of polyvinylpyrrolidone (K value 90, determined with 1% strength aqueous solution), 25 g of a 40% strength Luviquat FC 905 solution (copolymer of vinylpyrrolidone and vinyl-2-methylimidazolium methylsulfate: 5:95, K value about 40 determined using a 1% strength aqueous solution) and 180 g of polyethylene glycol of molar mass 1500 were weighed into a 2 l glass vessel fitted with anchor stirrer (200 rpm) and nitrogen line, and processed to give a homogeneous solution by stirring. 180 g of N-vinylformamide, 44.4 g of N-vinyl-2-methylimmidazolium methylsulfate (45% strength aqueous solution), and 0.6 g of triallylamine were added and the pH of the solution was then adjusted to 6.75 by adding 25% strength aqueous sodium hydroxide solution. Nitrogen was passed permanently through the reaction mixture and 1.0 g of 2,2′-azobis-2-(aminopropane) dihydrochloride (WakoV50) was added and the reaction mixture was heated to a temperature of 55° C. for the polymerization. The polymerization time was 4 hours. 0.24 g of 2,2′-azobis-2-(aminopropane) dihydrochloride (WakoVA44) was then added and the mixture was polymerized for a further 2 hours at 65° C.

This gave an aqueous dispersion with a solids content of 39.9%, a viscosity of 1100 mPas and an LD value (measured at 39.9% solids content) of <0.5.

### Example 11

### Feed Procedure

417.9 g of water, 2 g of sodium dihydrogenphosphate dihydrate, 6 g of polyvinylpyrrolidone (K value 90, determined with 1% strength aqueous solution), 10 g of polyvinylpyrrolidone (K value 17, determined with 1% strength aqueous solution) and 180 g of polyethylene glycol of molar mass 1500 were weighed into a 2 l glass vessel fitted with anchor stirrer (200 rpm) and nitrogen line, and processed to give a homogeneous solution by stirring. 160 g of N-vinylformamide, 88.9 g of N-vinyl-2-methylimmidazolium methylsulfate (45% aqueous solution), and 1.0 g of triallylamine were added and the pH of these solutions was then adjusted to 6.75 by adding 25% strength aqueous sodium hydroxide solution. Nitrogen was permanently passed through the reaction mixture and the reactibn mixture was heated to a temperature of 55° C. for the polymerization. 1.0 g of 2,2′-azobis-2-(aminopropane) dihydrochloride (WakoV50) in 100 ml of water was added over the course of 3 hours. The mixture was then polymerized for a further 3 hours. A further 0.3 g of 2,2′-azobis-2-(aminopropane) dihydrochloride (WakoV50) in 33 ml water was then added over 15 minutes and the mixture was polymerized for a further 2 hours at 75° C. This gave an aqueous dispersion with a solids content of 39.9%, a viscosity of 3400 mPas and an LD value (measured at 39.9% solids content) of <0.5%.

### Example 12

583 g of water, 2 g of sodium dihydrogenphosphate dihydrate, 6 g of polyvinylpyrrolidone (K value 90, determined with 1% strength aqueous solution), 6 g of polyvinylpyrrolidone (K value 17, determined with 1% strength aqueous solution) and 130 g of polyethylene glycol of molar mass 1500 and 50 g of polyethylene glycol of molar mass 4000 were weighed into a 2 l glass vessel fitted with anchor stirrer (200 rpm) and nitrogen line, and processed to give a homogeneous solution by stirring. 160 g of N-vinylformamide, 61.5 g of diallyldimethylammonium chloride (65% aqueous solution), and 0.2 g of triallylamine were added and the pH of these solutions was then adjusted to 6.75 by adding 25% strength aqueous sodium hydroxide solution. Nitrogen was passed permanently through the reaction mixture and 1.5 g of 2,2′-azobis-2-(aminopropane) dihydrochloride (WakoV50) was added and the reaction mixture was heated to a temperature of 55° C. for the polymerization. The polymerization time was 4 hours. Subsequently, 0.24 g of 2,2′-azobis-2-(aminopropane) dihydrochloride (WakoVA44) was added and the mixture was polymerized for a further 4 hours at 65° C.

This gave an aqueous dispersion with a solids content of 39.5%, a viscosity of 4600 mPas and an LD value (measured at 39.5% solids content) of <0.5%.

### Example 13

433 g of water, 2 g of sodium dihydrogenphosphate dihydrate, 6 g of polyvinylpyrrolidone (K value 90, determined with 1% strength aqueous solution), 6 g of polyvinylpyrrolidone (K value 17, determined with 1% strength aqueous solution) and 130 g of polyethylene glycol of molar mass 1500 were weighed into a 2 l glass vessel fitted with anchor stirrer (200 rpm) and nitrogen line, and processed to give a homogeneous solution by stirring. 160 g of N-vinylformamide, 61.5 g of diallyldimethylammonium chloride (65% aqueous solution), and 0.2 g of triallylamine were added and the pH of these solutions was then adjusted to 6.75 by adding 25% strength aqueous sodium hydroxide solution. Nitrogen was passed permanently through the reaction mixture and 1.5 g of 2,2′-azobis-2-(aminopropane) dihydrochloride (WakoV50) was added and the reaction mixture was heated to a temperature of 55° C. for the polymerization. The polymerization time was 4 hours. During the polymerization, 50 g of polyethylene glycol of molar mass 1500 in 150 g of water was added after 2 hours over the course of 2 hours. Subsequently, 0.24 g of 2,2′-azobis-2-(aminopropane) dihydrochloride (WakoVA44) was added and the mixture was polymerized for a further 4 hours at 75° C. This gave an aqueous dispersion with a solids content of 39.5%, a viscosity of 2600 mPas and an LD value (measured at 39.5% solids content) of <0.5%.

### Example 14

575.7 g of water, 2 g of sodium dihydrogenphosphate dihydrate, 6 g of polyvinylpyrrolidone (K value 90, determined with 1% strength aqueous solution), 10 g of polyvinylpyrrolidone (K value 17, determined with 1% strength aqueous solution) and 180 g of polyethylene glycol of molar mass 1500 were weighed into a 2 l glass vessel fitted with anchor stirrer (200 rpm) and nitrogen line, and processed to give a homogeneous solution by stirring. 30 g of N-vinylformamide, 7.4 g of N-vinyl-2-methylimmidazolium methylsulfate (45% aqueous solution), and 0.6 g of triallylamine were added, and the pH of the solution was adjusted to 6.75 by adding 25% strength aqueous sodium hydroxide solution. Nitrogen was passed permanently through the reaction mixture and 1 g of 2,2′-azobis-2-(aminopropane) dihydrochloride (WakoV50) was added and the reaction mixture was heated to a temperature of 50° C. for the polymerization. The polymerization time was 6 hours. A further 150 g of N-vinylformamide, 37 g of N-vinyl-2-methylimmidazolium methylsulfate (45% aqueous solution) were run in during the polymerization in the first 3 hours of the polymerization time. 0.4 g of 2,2′-azobis-2-(aminopropane) dihydrochloride (WakoVA44) was then added and the mixture was polymerized for a further 2 hours at 65° C.

This gave an aqueous dispersion with a solids content of 39.9%, a viscosity of 6500 mPas and an LD value (measured at 39.9% solids content) of <0.5.

### Example 15

550.9 g of water, 2 g of sodium dihydrogen phosphate dihydrate, 8 g of polyethylene glycol of molar mass 35 000, and 180 g of polyethylene glycol of molar mass 1500 were weighed into a 2 l glass vessel fitted with anchor stirrer (200 rpm) and nitrogen line, and processed to give a homogeneous solution by stirring. 180 g of N-vinylformamide, 44.4 g of N-vinyl-2-methylimmidazolium methylsulfate (45% aqueous solution), and 0.6 g of triallylamine were added and the pH of the solution was adjusted to 6.75 by adding 25% strength aqueous sodium hydroxide solution. Nitrogen was passed permanently through the reaction mixture and 1.0 g of 2,2′-azobis-2-(aminopropane) dihydrochloride (WakoV50) was added and the reaction mixture was heated to a temperature of 55° C. for the polymerization. The polymerization time was 4 hours. 0.24 g of 2,2′-azobis-2-(aminopropane) dihydrochloride (WakoVA44) was then added and the mixture was polymerized for a further 2 hours at 65° C.

This gave an aqueous dispersion with a solids content of 39.9%, a viscosity of 1900 mPas and an LD value (measured at 39.9% solids content) of <0.5.

### Example 16

800 g of water, 5 g of sodium dihydrogenphosphate dihydrate, 150 g of polyvinylpyrrolidone (K value 30, determined with 1% strength aqueous solution) and 150 g of polyethylene glycol of molar mass 1500 were weighed into a 2 l glass vessel fitted with anchor stirrer, nitrogen line, distillation bridge and vacuum regulation, and processed to give a homogeneous solution by stirring. 400 g of N-vinylformamide, 155 g of diallyldimethylammonium chloride (65% aqueous solution) and 2.0 g of pentaerythrityl triallyl ether were added and then the pH of the solution was adjusted to 6.5 by adding 25% strength aqueous sodium hydroxide solution. Nitrogen was passed permanently through the reaction mixture, and a solution of 2.5 g of 2,2′-azobis-2-(aminopropane) dihydrochloride in 100 g of water was added and the reaction mixture was heated to a temperature of 50° C. for the polymerization. The polymerization was carried out at this temperature and a pressure of 130 mbar, the heat of polymerization which resulted being dissipated by hot cooling. The polymerization time was 3 hours. Within this period, enough water was distilled off to give an aqueous dispersion with a solids content of 44%. It had a viscosity of 4800 mPas and an LD value of <0.5% (measured at 44% solids content).

Abbreviations Used

VFA vinylformamide

QVI quaternized vinylimidazole

Pluriol E INCI polyethylene glycol

Kollidon 90 F INCI PVP

Kollidon 17 PF INCI PVP

### PREPARATION EXAMPLES OF (METH)ACRYLAMIDE-CONTAINING DISPERSIONS

Abbreviations

PVP polyvinylpyrrolidone (Luviskol K 30)

EDTA ethylenediaminetetraacetic acid

PEG polyethylene glycol

AM acrylamide

DADMAC diallyldimethylammonium chloride

AA acrylic acid

DMA3*MeCl dimethylaminoethyl acrylate quaternized with CH₃Cl

QVI vinylimidazole quaternized with dimethyl sulfate

V-50™ 2,2′-azobis(2-methylpropionamide) dihydrochloride

VA-044™ 2,2′-azobis[2-(2-imidazolin-2-yl)propane] dihydrochloride

### Example (M)A 1

90 g of a 30% strength by weight aqueous PVP solution and 0.1 g of a 40% strength by weight aqueous solution of EDTA were dissolved in 275 g of water and 120 g of PEG (Pluriol™ E 1500) were added. The pH was adjusted to 6.75 with triethanolamine and the emulsion was flushed with nitrogen gas for 10 minutes.

A mixture of 348 g of a 50% strength by weight aqueous solution of AM, 133.1 g of a 45% strength by weight aqueous solution of QVI was then added over the course of 10 minutes. 0.23 g of the free-radical initiator V-50™ were then added and the reaction mixture was heated to 50° C. under a nitrogen atmosphere. After the mixture had been stirred at this temperature for 4 hours, 0.25 g of the free-radical initiator VA-044™ were added and the mixture was stirred for a further 2 hours at 60° C. and then cooled to room temperature. This gave a white dispersion with a viscosity of 670 mPa*s.

### Example (M)A2

135 g of a 30% strength by weight aqueous PVP solution and 0.1 g of a 40% strength by weight aqueous solution of EDTA were added to 255 g of water and 105 g of PEG (Pluriol™ E 1500) were added. The pH was adjusted to 6.75 with triethanolamine and the emulsion was flushed for 10 minutes with nitrogen gas.

A mixture of 348 g of a 50% strength by weight aqueous solution of AM and 72.5 g of a 60.7% strength by weight aqueous solution of DADMAC was then added over the course of 10 minutes. 0.1 g of the free-radical initiator V-50™ in 50 g of water were then added continuously over the course of 2 hours and the reaction mixture was heated to 60° C. under a nitrogen atmosphere. After the mixture had been stirred for 2 hours at this temperature, 0.1 g of the free-radical initiator VA-044™ were added and the mixture was stirred at 70° C. for one hour and then cooled to room temperature.

This gave a white dispersion with a viscosity of 1520 mPa*s.

### Example (M)A 3

90 g of a 30% strength by weight aqueous PVP solution and 0.1 g of a 40% strength by weight aqueous solution of EDTA were added to 275 g of water and 120 g of PEG (Pluriol™ E 1500) were added. The pH was adjusted to 6.75 with triethanolamine and the emulsion was flushed for 10 minutes with nitrogen gas.

A mixture of 348 g of a 50% strength by weight aqueous solution of AM and 133.1 g of a 45% strength by weight aqueous solution of QVI was then added over the course of 10 minutes. 0.1 g of the free-radical initiator V-50™ was then added and the reaction mixture was heated to 60° C. under a nitrogen atmosphere. After the mixture had been stirred for 4 hours at this temperature, 0.1 g of the free-radical initiator VA-044™ was added and the mixture was stirred at 60° C. for one hour and then cooled to room temperature. This gave a white dispersion with a viscosity of 410 mPa*s.

### Example (M)A4

90 g of a 30% strength by weight aqueous PVP solution and 0.1 g of a 40% strength by weight aqueous solution of EDTA and 30 g of NaCl were dissolved in 275 g of water and 120 g of PEG (Pluriol™ E 1500) were added. The pH was adjusted to 6.75 with triethanolamine and the emulsion was flushed for 10 minutes with nitrogen gas.

A mixture of 313.5 g of a 50% strength by weight aqueous solution of AM, 133.1 g of a 45% strength by weight aqueous solution of QVI and 17.7 g of AA was then added over the course of 10 minutes.

0.1 g of the free-radical initiator V-50™ was then added and the reaction mixture was heated to 60° C. under a nitrogen atmosphere. After the mixture had been stirred for 4 hours at this temperature, 0.1 g of the free-radical initiator VA-044™ were added and the mixture was stirred at 60° C. for a further hour and then cooled to room temperature. This gave a white dispersion with a viscosity of 550 mPa*s.

### Example (M)A 5

90 g of a 30% strength by weight aqueous PVP solution and 0.1 g of a 40% strength by weight aqueous solution of EDTA were dissolved in 275 g of water and 120 g of PEG (Pluriol™ E 1500) were added. The pH was adjusted to 6.75 with triethanolamine and the emulsion was flushed with nitrogen gas for 10 minutes.

A mixture of 348 g of a 50% strength by weight aqueous solution of AM, 133.1 g of a 45% strength by weight aqueous solution of QVI and 0.373 g of triallylamine was then added over the course of 10 minutes.

0.1 g of the free-radical initiator V-50™ was then added and the reaction mixture was heated to 60° C. under a nitrogen atmosphere. After the mixture had been stirred for 4.25 hours at this temperature, 0.1 g of the free-radical initiator VA-044™ were added and the mixture was stirred for a further hour at 60° C. and then cooled to room temperature.

This gave a white dispersion with a viscosity of 650 mPa*s.

### Example (M)A 6

135 g of a 30% strength by weight aqueous PVP solution and 0.1 g of a 40% strength by weight aqueous solution of EDTA were dissolved in 167 g of water and 135 g of PEG (Pluriol™ E 1500) were added. The pH was adjusted to 6.75 with triethanolamine and the emulsion was flushed with nitrogen gas for 10 minutes.

A mixture of 348 g of a 50% strength by weight aqueous solution of AM, 56.66 g of an 80% strength by weight aqueous solution of DMA3*MeCl was then added over the course of 10 minutes. 0.1 g of the free-radical initiator V-50™ was then added and the reaction mixture was heated to 60° C. under a nitrogen atmosphere. After the mixture had been stirred for 3 hours at this temperature, 0.1 g of the free-radical initiator VA-044™ were added and the mixture was stirred for a further hour at 60° C. and then cooled to room temperature. This gave a white dispersion with a viscosity of 2260 mPa*s.

The Brookfield viscosity measurement was measured at 25° C., with spindle 4 and 12 revolutions.

The determination of the decrease in combing force was carried out as follows:

Determination of the blank value for wet combability: The washed hair was dried overnight in a climatically controlled room. Prior to measurement, it was shampooed twice with Texapon NSO for a total of 1 minute and rinsed for 1 minute so that it is definedly wet, i.e. swollen. Prior to the start of the measurement, the tress was precombed until no more tangles in the hair are present and thus a constant application of force is required for repeated measurement combing. The tress was then fixed onto the holder and, using the fine-toothed side of the comb, is combed into the fine-toothed side of the test comb. The insertion of the hair into the test comb was carried out uniformly and free from tension for each measurement. The measurement was started and evaluated by means of software (EGRANUDO program, Frank). The individual measurement was repeated 5 to 10 times. The calculated average was noted.

Determination of the measurement value for wet combability: After determining the blank value, the hair was treated in each case according to the desired application. The combing force is measured analogously to the blank value determination.

Evaluation:
Combing force decrease wet [%]=100−(measurement value*100/blank value)
Determination of the Blank Value for Dry Combability:

The washed hair is dried overnight in a climatically controlled room. Prior to the start of the measurement, the tress is precombed until no more tangles of the hair are present and thus a constant application of force is required for repeated measurement combing. The tress is then fixed to the holder and combed into the fine-toothed side of the test comb. For each measurement, the insertion of the hair into the test comb has to be carried out uniformly and free from tension. The measurement is started and evaluated by means of software (mtt-win, DIASTRON). The individual measurement is repeated 5-10 times. The calculated average is noted together with the standard deviation.

Determination of the Measurement Value for Dry Combability:

After determining the blank value, the hair is treated according to the desired application and dried overnight. The combing force is measured analogously to the blank value determination.

Evaluation:
Combing force decrease dry [%]=100−(measurement value*100/blank value)

The results of examples 1 to 3 and also comparative examples C1 to C3 are summarized in table 1:

TABLE 1

| | | | | Pluriol E 1500 | Polymeric | | | | Decrease in | | Decrease in | |
|---|---|---|---|---|---|---|---|---|---|---|---|---|
| | | | | polymeric | dispersant b) | | Dispersion | | combing | | combing | |
| | VFA | QVI | Triallylamine | precipitation | [% by wt.] | | solids | Viscosity | force | | force | |
| | Monomer a) | Monomer e) | monomer d) | agent c) | Kollidon | Kollidon | content | [mPas] | [grade] | | [in %] | |
| No. | [% by wt.] | [% by wt.] | [% by wt.] | [% by wt.] | 90 | 17 | [% by wt.]# | Tel quel | Wet | Dry | Wet | Dry |
| 1 | 18 | 2 | 0.06 | 18 | 3 | 5 | 46.06 | 650 | 1- | 1 | 65 | 92 |
| 2 | 16 | 4 | 0.1 | 18 | 3 | 5 | 46.1 | 5900 | 1-2 | 1 | 59 | 95 |
| 3 | 18 | 2 | 0.04 | 18 | 6 | 5 | 49.04 | 8600 | 1- | 1 | 71 | 95 |
| C1 | 18 | 2 | 0.06 | — | — | — | 20.06 | >75000 | 2-3 | —* | 24 | — |
| C2 | 16 | 4 | 0.1 | — | — | — | 20.1 | >75000 | 2 | —* | 32 | |
| C3 | 18 | 2 | — | 18 | 5 | 5 | 49 | 2600 | 2- | —* | 28 | — |

#Water is added to 100% by weight
*Not measured because wet combability was too low.

Shampoo Formulations Containing Polymers from Examples (M)A 1 to 6

| | | | |
|---|---|---|---|
| Formulation: | 35.70 | g | Texapon NSO |
| | 12.50 | g | Tego Betain L7 |
| | 0.50 | g | Polymer |
| | 0.10 | g | Euxyl K 100 |
| | ad 100 | g | water |

| Dispersion | Solids content | Monomers | Monomer | Wet combability | Wet combability | Combing force |
|---|---|---|---|---|---|---|
| [name as in | in dispersion | [name as in | ratio | untreated by hand | treated by hand | decrease of the wet |
| examples] | [% by wt.] | examples] | [mol %] | (grade 1-3) | (grade 1-3) | combability [%] |
| (M)A 1 | 24.2 | AM/QVI | 90/10 | 2-3 | 1-2 | 37 |
| (M)A 2 | 23.8 | AM/DADMAC | 90/10 | 2-3 | 1-2 | 35 |
| (M)A 3 | 23.5 | AM/QVI | 90/10 | 2-3 | 1-2 | 39 |
| (M)A 4 | 23.5 | AM/AA/QVI | 80/10/10 | 2-3 | 1-2 | 43 |
| (M)A 5 | 23.5 | AM/QVI | 90/10 | 2-3 | 1-2 | 43 |
| (M)A 6 | 26.6 | AM/DMA3.CH₃Cl | 90/10 | 2-3 | 1-2 | 40 |
| (M)A 5 | 23.5 | AM/QVI | 90/10 | 2-3 | 1-2 | 43 |

The dispersions according to the invention (examples 1 to 3) display excellent hair cosmetic properties. They can be prepared with a high solids content coupled with a desired low viscosity. The corresponding dispersions prepared without crosslinker (comparative example C3) exhibit unsatisfactory hair cosmetic properties. The preparation in the presence of a crosslinker is obligatorily necessary to achieve the performance properties. Polymers which are prepared without polymeric dispersant and polymeric precipitation agent (comparative example C1) are not accessible on a large scale due to their high solution viscosity. In addition, their hair cosmetic properties are unsatisfactory compared with those of the dispersions according to the invention. For the preparation of polymers classified as excellent in terms of performance, the presence of a polymeric precipitation agent (in particular PEG) and of a suitable polymeric dispersant is therefore necessary.

### EXAMPLES OF COSMETIC PREPARATIONS

### All Data in % by Weight

In all formulations, the dispersions obtained according to examples 1, 3, 4, 7 and 11 were used.

### Example 1

### Liquid Make-Up

A

1.70 Glyceryl stearate

1.70 Cetyl alcohol

1.70 Ceteareth-6

1.70 Ceteareth-25

5.20 Caprylic/capric triglyceride

5.20 Mineral oil

B

q.s. Preservative

4.30 Propylene glycol

2.50 Dispersion according to the invention

59.50 Dist. water

C

q.s. Perfume oil

D

2.00 Iron oxides

12.00 Titanium dioxide

Preparation:

Heat phase A and phase B separately from one another to 80° C. Then mix phase B into phase A using a stirrer. Allow everything to cool to 40° C. and add phase C and phase D. Homogenize repeatedly.

### Example 2

### Oil-Free Make-Up

A

0.35 Veegum

5.00 Butylene glycol

0.15 Xanthan gum

B

53.0 Dist. water

q.s. Preservative

0.2 Polysorbate-20

1.6 Tetrahydroxypropylethylenediamine

C

1.0 Silica

2.0 Nylone-12

4.15 Mica

6.0 Titanium dioxide

1.85 Iron oxides

D

4.0 Stearic acid

1.5 Glyceryl stearate

7.0 Benzyl laurate

5.0 Isoeicosane

q.s. Preservative

E

1.0 Dist. water

0.5 Panthenol

0.1 Imidazolidinylurea

5.0 Dispersion according to the invention

Preparation:

Wet phase A with butylene glycol, add to phase B and mix well. Heat phase AB to 75° C. Pulverize phase C feed substances, add to phase AB and homogenize well. Mix feed substances of phase D, heat to 80° C. and add to phase ABC. Mix for some time until everything is homogeneous. Transfer everything to a vessel with a propeller mixer. Mix feed substances of phase E, add to phase ABCD and mix well.

### Example 3

### Eyeliner

A

40.6 Dist. water

0.2 Disodium EDTA

q.s. Preservative

B

0.6 Xanthan gum

0.4 Veegum

3.0 Butylene glycol

0.2 Polysorbate-20

C

15.0 Iron oxide/Al powder/silica (e.g. Sicopeal Fantastico Gold™ from BASF)

D

10.0 Dist. water

30.0 Dispersion according to the invention

Preparation:

Premix phase B. Mix phase B into phase A using a propeller mixer, allowing the thickener to swell. Wet phase C with phase D, add everything to phase AB and mix well.

### Example 4

### Shimmer Gel

A

32.6 Dist water

0.1 Disodium EDTA

25.0 Carbomer (2% strength aqueous solution)

0.3 Preservative

B

0.5 Dist. water

0.5 Triethanolamine

C

10.0 Dist. water

9.0 Dispersion according to the invention

1.0 Polyquaternium-46

5.0 Iron oxide

D

15.0 Dist. water

1.0 D-Panthenol 50 P (panthenol and propylene glycol)

Preparation:

Using a propeller mixer, thoroughly mix the feed substances of phase A in the given sequence. Then add phase B to phase A Stir slowly until everything is homogeneous. Thoroughly homogenize phase C until the pigments are well distributed. Add phase C and phase D to phase AB and mix well.

### Example 5

### Water-Resistant Mascara

A

46.7 Dist. water

3.0 Lutrol E 400 (PEG-8)

0.5 Xanthan gum

q.s. Preservative

0.1 Imidazolidinylurea

1.3 Tetrahydroxypropylethylenediamine

B

8.0 Carnauba wax

4.0 Beeswax

4.0 Isoeicosane

4.0 Polyisobutene

5.0 Stearic acid

1.0 Glyceryl stearate

q.s. Preservative

2.0 Benzyl laurate

C

10.0 Iron oxide/Al powder/silica (e.g. Sicopearl Fantastico Gold™ from BASF)

E

8.0 Polyurethane-1

2.0 Dispersion according to the invention

Preparation:

Heat phase A and phase B separately from one another to 85° C. Maintain the temperature and add phase C to phase A and homogenize until the pigments are uniformly distributed. Add phase B to phases AC and homogenize for 2-3 minutes. Then add phase E and slowly stir. Allow everything to cool to room temperature.

### Example 6

### Sunscreen Gel

Phase A

1.00 PEG-40 hydrogenated castor oil

8.00 Octyl methoxycinnamate (Uvinul MC80™ from BASF)

5.00 Octocrylene (Uvinul N539™ from BASF)

0.80 Octyltriazone (Uvinul T 150 from BASF)

2.00 Butylmethoxydibenzoylmethane (Uvinul BMBM™ from BASF)

2.00 Tocopheryl acetate

q.s. Perfume oil

Phase B

2.50 Dispersion according to the invention

0.30 Acrylates/C10-30 alkyl acrylate crosspolymer

0.20 Carbomer

5.00 Glycerol

0.20 Disodium EDTA.

q.s. Preservative

72.80 Dist. water

Phase C

0.20 Sodium hydroxide

Preparation:

Mix the components of phase A. Allow phase B to swell and stir into phase A with homogenization. Neutralize with phase C and homogenize again.

### Example 7

### Sunscreen Emulsion Containing TiO₂ and ZnO₂

Phase A

6.00 PEG-7 hydrogenated castor oil

2.00 PEG-45/dodecyl glycol copolymer

3.00 Isopropyl myristate

8.00 Jojoba (Buxus chinensis) oil

4.00 Octyl methoxycinnamate (Uvinul MC 80)

2.00 4-Methylbenzylidenecamphor (Uvinul MBC 95)

3.00 Titanium dioxide, dimethicone

1.00 Dimethicone

5.00 Zinc oxide, dimethicone

Phase B

2.00 Dispersion according to the invention

0.20 Disodium EDTA

5.00 Glycerol

q.s. Preservative

58.80 Dist. water

Phase C

q.s. Perfume oil

Preparation:

Heat phases A and B separately to about 85° C. Stir phase B into phase A and homogenize. Cool to about 40° C., add phase C and briefly homogenize again.

### Example 8

### Sun Protection Lotion

Phase A

6.00 Octyl methoxycinnamate (Uvinul MC 80™ from BASF)

2.50 4-Methylbenzylidenecamphor (Uvinul MBC95™ from BASF)

1.00 Octyltriazone (Uvinul T 150™ from BASF)

2.00 Butylmethoxydibenzoylmethane (Uvinul BMBM™ from BASF)

2.00 PVP/hexadecene copolymer

5.00 PPG-3 myristyl ether

0.50 Dimethicone

0.10 BHT, ascorbyl palmitate, citric acid, glyceryl stearate, propylene glycol

2.00 Cetyl alcohol

2.00 Potassium cetyl phosphate

Phase B

2.50 Dispersion according to the invention

5.00 Propylene glycol

0.20 Disodium EDTA

q.s. Preservative

63.92 Dist. water

Phase C

5.00 Mineral oil

0.20 Carbomer

Phase D

0.08 Sodium hydroxide

Phase E

q.s. Perfume oil

Preparation:

Phases A and B are heated separately to about 80° C. Stir phase B into phase A with homogenization, briefly after-homogenize. Make phase C into a paste, stir into phase AB, neutralize with phase D and after-homogenize. Cool to about 40° C., add phase E, homogenize again.

### Example 9

### Removable Face Mask

Phase A

57.10 Dist. water

6.00 Polyvinyl alcohol

5.00 Propylene glycol

Phase B

20.00 Alcohol

4.00 PEG-32

q.s Perfume oil

Phase C

5.00 Polyquaternium-44

2.70 Dispersion according to the invention

0.20 Allantoin

Preparation:

Heat phase A to at least 90° C. and stir until dissolved. Dissolve phase B at 50° C. and stir into phase A. At about 35° C., make up the loss of ethanol. Add phase C and stir.

### Example 10

### Face Mask

Phase A

3.00 Ceteareth-6

1.50 Ceteareth-25

5.00 Cetearyl alcohol

6.00 Cetearyl octanoate

6.00 Mineral oil

0.20 Bisabolol

3.00 Glyceryl stearate

Phase B

2.00 Propylene glycol

5.00 Panthenol

2.80 Dispersion according to the invention

q.s. Preservative

65.00 Dist. water

Phase C

q.s. Perfume oil

0.50 Tocopheryl acetate

Preparation:

Heat phase A and B separately to about 80° C. Stir phase B into phase A with homogenization, briefly after-homogenize. Cool to about 40° C., add phase C, homogenize again.

### Example 11

### Body Lotion Mousse

Phase A

1.50 Ceteareth-25

1.50 Ceteareth-6

4.00 Cetearyl alcohol

10.00 Cetearyl octanoate

1.00 Dimethicone

Phase B

3.00 Dispersion according to the invention

2.00 Panthenol

2.50 Propylene glycol

q.s. Preservative

74.50 Dist. water

Phase C

q.s. Perfume oil

Preparation:

Heat phases A and B separately to about 80° C., stir phase B into phase A and homogenize. Cool to about 40° C., add phase C and briefly homogenize again. Bottling: 90% active ingredient and 10% propane/butane at 3.5 bar (20° C.).

### Example 12

### Face Tonic for Dry and Sensitive Skin

Phase A

2.50 PEG-40 hydrogenated castor oil

q.s. Perfume oil

0.40 Bisabolol

Phase B

3.00 Glycerol

1.00 Hydroxyethylcetyldimonium phosphate

5.00 Whitch hazel (Hamameiis virginiana) distillate

0.50 Panthenol

0.50 Dispersion according to the invention

q.s. Preservative

87.60 Dist. water

Preparation:

Dissolve phase A until clear. Stir phase B into phase A.

### Example 13

### Face Wash Paste with Peeling Effect

Phase A

70.00 Dist. water

3.00 Dispersion according to the invention

1.50 Carbomer

q.s. Preservative

Phase B

q.s. Perfume oil

7.00 Potassium cocoyl hydrolyzed protein

4.00 Cocamidopropylbetaine

Phase C

1.50 Triethanolamine

Phase D

13.00 Polyethylene (Luwax A™ from BASF)

Preparation:

Allow phase A to swell. Dissolve phase B until clear. Stir phase B into phase A. Neutralize with phase C. Then stir in phase D.

Face Soap

Phase A

Potassium cocoate

Disodium cocoamphodiacetate

2.0 lauramide DEA

Glycol stearate

2.0 Dispersion according to the invention

50.0 Dist. water

q.s. Citric acid

Phase B

q.s. Preservative

q.s. Perfume oil

Preparation:

Heat phase A with stirring to 70° C. until everything is homogeneous. Adjust pH to 7.0-7.5 with citric acid. Allow everything to cool to 50° C. and add phase B.

### Example 14

### Face Cleansing Milk O/W Type

Phase A

1.50 Ceteareth-6

1.50 Ceteareth-25

2.00 Glyceryl stearate

2.00 Cetyl alcohol

10.00 Mineral oil

Phase B

5.00 Propylene glycol

q.s. Preservative

1.0 Dispersion according to the invention

66.30 Dist. water

Phase C

0.20 Carbomer

10.00 Cetearyl octanoate

Phase D

0.40 Tetrahydroxypropylethylenediamine

Phase E

q.s. Perfume oil

0.10 Bisabolol

Preparation:

Heat phases A and B separately to about 80° C. Stir phase B into phase A with homogenization, briefly after-homogenize. Make phase C into a paste, stir into phase AB, neutralize with phase D and after-homogenize. Cool to about 40° C., add phase E, homogenize again.

### Example 15

### Transparent Soap

4.20 Sodium hydroxide

3.60 Dist. water

2.0 Dispersion according to the invention

22.60 Propylene glycol

18.70 Glycerol

5.20 Cocoamide DEA

10.40 Cocamine oxide

4.20 Sodium lauryl sulfate

7.30 Myristic acid

16.60 Stearic acid

5.20 Tocopherol

Preparation:

Mix all of the ingredients. Melt the mixture until clear at 85° C. Immediately pour out into the mold.

### Example 16

### Peeling Cream, O/W Type

Phase A

3.00 Ceteareth-6

1.50 Ceteareth-25

3.00 Glyceryl stearate

5.00 Cetearyl alcohol, sodium cetearyl sulfate

6.00 Cetearyl octanoate

6.00 Mineral oil

0.20 Bisabolol

Phase B

2.00 Propylene glycol

0.10 Disodium EDTA

3.00 Dispersion according to the invention

q.s. Preservative

59.70 Dist. water

Phase C

0.50 Tocopheryl acetate

q.s. Perfume oil

Phase D

10.00 Polyethylene

Preparation:

Heat phases A and B separately to about 80° C. Stir phase B into phase A and homogenize. Cool to about 40° C., add phase C and briefly homogenize again. Then stir in phase D.

### Example 17

### Shaving Foam

6.00 Ceteareth-25

5.00 Poloxamer 407

52.00 Dist. water

1.00 Triethanolamine

5.00 Propylene glycol

1.00 PEG-75 lanolin oil

5.00 Dispersion according to the invention

q.s. Preservative

q.s. Perfume oil

25.00 Sodium laureth sulfate

Preparation:

Weigh everything in together, then stir until dissolved. Bottling: 90 parts of active substance and 10 parts of propane/butane mixture 25:75.

### Example 18

### Aftershave Balsam

Phase A

0.25 Acrylates/C10-30 alkyl acrylate crosspolymer

1.50 Tocopheryl acetate

0.20 Bisabolol

10.00 Caprylic/capric triglyceride

q.s. Perfume oil

1.00 PEG-40 hydrogenated castor oil

Phase B

1.00 Panthenol

15.00 Alcohol

5.00 Glycerol

0.05 Hydroxyethyl cellulose

1.92 Dispersion according to the invention

64.00 Dist. water

Phase C

0.08 Sodium hydroxide.

Preparation:

Mix the components of phase A Stir phase B into phase A with homogenization, briefly after-homogenize. Neutralize with phase C and homogenize again.

### Example 19

### Bodycare Cream

Phase A

2.00 Ceteareth-6

2.00 Ceteareth-25

2.00 Cetearyl alcohol

3.00 Glyceryl stearate SE

5.00 Mineral oil

4.00 Jojoba (Buxus chinensis) oil

3.00 Cetearyl octanoate

1.00 Dimethicone

3.00 Mineral oil, lanolin alcohol

Phase B

5.00 Propylene glycol

0.50 Veegum

1.00 Panthenol

1.70 Dispersion according to the invention

6.00 Polyquaternium-44

q.s. Preservative

60.80 Dist. water

Phase C

q.s. Perfume oil

Preparation:

Heat phases A and B separately to about 80° C. Homogenize phase B. Stir phase B into phase A with homogenization, briefly after-homogenize. Cool to about 40° C., add phase C and briefly homogenize again.

### Example 20

### Toothpaste

Phase A

34.79 Dist. water

3.00 Dispersion according to the invention

0.30 Preservative

20.00 Glycerol

0.76 Sodium monofluorophosphate

Phase B

1.20 Sodium carboxymethylcellulose

Phase C

0.80 Aroma oil

0.06 Saccharin

0.10 Preservative

0.05 Bisabolol

1.00 Panthenol

0.50 Tocopheryl acetate

2.80 Silica

1.00 Sodium lauryl sulfate

7.90 Dicalcium phosphate anhydrate

25.29 Dicalcium phosphate dihydrate

0.45 Titanium dioxide

Preparation:

Dissolve phase A. Scatter phase B into phase A and dissolve. Add phase C and stir under reduced pressure at RT for about 45 min.

### Example 21

### Mouthwash

Phase A

2.00 Aroma oil

4.00 PEG-40 hydrogenated castor oil

1.00 Bisabolol

30.00 Alcohol

Phase B

0.20 Saccharin

5.00 Glycerol

q.s. Preservative

5.00 Poloxamer 407

0.5 Dispersion according to the invention

52.30 Dist. water

Preparation:

Dissolve phase A and phase B separately until clear. Stir phase B into phase A.

### Example 22

### Prosthesis Adhesive

Phase A

0.20 Bisabolol

1.00 Beta-carotene

q.s. Aroma oil

20.00 Cetearyl octanoate

5.00 Silica

33.80 Mineral oil

Phase B

5.00 Dispersion according to the invention

35.00 PVP (20% strength solution in water)

Preparation:

Mix phase A well. Stir phase B into phase A.

### Example 23

### Skincare Cream, O/W Type

Phase A

8.00 Cetearyl alcohol

2.00 Ceteareth-6

2.00 Ceteareth-25

10.00 Mineral oil

5.00 Cetearyl octanoate

5.00 Dimethicone

Phase B

3.00 Dispersion according to the invention

2.00 Panthenol, propylene glycol

q.s. Preservative

63.00 Dist. water

Phase C

q.s. Perfume oil

Preparation:

Heat phase A and B separately to about 80° C. Stir phase B into phase A with homogenization, briefly after-homogenize. Cool to about 40° C., add phase C, homogenize again.

### Example 24

### Skincare Cream, W/O Type

Phase A

6.00 PEG-7 hydrogenated castor oil

8.00 Cetearyl octanoate

5.00 Isopropyl myristate

15.00 Mineral oil

2.00 PEG-45/dodecyl glycol copolymer

0.50 Magnesium stearate

0.50 Aluminum stearate

Phase B

3.00 Glycerol

3.30 Dispersion according to the invention

0.70 Magnesium sulfate

2.00 Panthenol

q.s. Preservative

48.00 Dist. water

Phase C

1.00 Tocopherol

5.00 Tocopheryl acetate

q.s. Perfume oil

Preparation:

Heat phases A and B separately to about 80° C. Stir phase B into phase A and homogenize. Cool to about 40° C., add phase C and briefly homogenize again.

### Example 25

### Lip Care Cream

Phase A

10.00 Cetearyl octanoate

5.00 Polybutene

Phase B

0.10 Carbomer

Phase C

2.00 Ceteareth-6

2.00 Ceteareth-25

2.00 Glyceryl stearate

2.00 Cetyl alcohol

1.00 Dimethicone

1.00 Benzophenone-3

0.20 Bisabolol

6.00 Mineral oil

Phase D

8.00 Dispersion according to the invention

3.00 Panthenol

3.00 Propylene glycol

q.s. Preservative

54.00 Dist. water

Phase E

0.10 Triethanolamine

Phase F

0.50 Tocopheryl acetate

0.10 Tocopherol

q.s. Perfume oil

Preparation:

Dissolve phase A until clear. Add phase B and homogenize. Add phase C and melt at 80° C. Heat phase D to 80° C. Add phase D to phase ABC and homogenize. Cool to about 40° C., add phase E and phase F, homogenize again.

### Example 26

### Shimmer Lipstick

Phase A

5.30 Candelilla (Euphorbia cerifera) wax

1.10 Beeswax

1.10 Microcrystalline wax

2.00 Cetyl palmitate

3.30 Mineral oil

2.40 Castor oil, glyceryl ricinoleate, octyldodecanol, carnauba, candelilla wax,

0.40 bisabolol

16.00 Cetearyl octanoate

2.00 Hydrogenated cocoglycerides

q.s. Preservative

1.00 Dispersion according to the invention

60.10 Castor (Ricinus communis) oil

0.50 Tocopheryl acetate

Phase B

0.80 C. I. 14 720:1, Acid Red 14 aluminum lake

Phase C

4.00 Mica, titanium dioxide

Preparation:

Weigh in the components of phase A and melt. Incorporate phase B homogenously. Add phase C and stir in. Cool to room temperature with stirring.

### Example 26

### Shower Gel

50.00 Sodium laureth sulfate, magnesium laureth sulfate, sodium laureth-8 sulfate, magnesium laureth-8

1.00 Cocoamide DEA

4.00 Dispersion according to the invention

2.00 Sodium laureth sulfate, glycol distearate, cocamide MEA, laureth-10

q.s. Preservative

q.s. Perfume oil

2.00 Sodium chloride

41.00 Aqua, demin.

Preparation:

Weigh everything in together, stir until dissolved.

### Example 27

### Shower Gel

30.00 Sodium laureth sulfate

6.00 Sodium cocoamphodiacetate

6.00 Cocamidopropyl betaine

3.00 Sodium laureth sulfate, glycol distearate, cocamide MEA, laureth-10

7.70 Polyquaternium-44

1.50 Dispersion according to the invention

1.00 Panthenol

q.s. Preservative

q.s. Perfume oil

q.s. Citric acid

0.50 Sodium chloride

44.30 Aqua, demin.

Preparation:

Weigh in the components of phase A and dissolve. Adjust the pH to 6-7.

### Example 28

### Clear Shower Gel

40.00 Sodium laureth sulfate

5.00 Decyl glucoside

5.00 Cocamidopropyl betaine

0.50 Polyquatemium-10

2.20 Dispersion according to the invention

1.00 Panthenol

q.s. Perfume oil

q.s. Preservative

q.s. Citric acid

2.00 Sodium chloride

44.30 Aqua, demin.

Preparation:

Weigh in the components of phase A and stir until clear.

### Example 29

### Shower Bath

A

40.00 Sodium laureth sulfate

5.00 Sodium C12-15 pareth-15 sulfonate

5.00 Decyl glucoside

q.s. Perfume oil

0.10 Phytantriol

B

43.60 Aqua, demin.

0.1 Guarhydroxypropyl trimoniumchloride

2.20 Dispersion according to the invention

1.00 Panthenol

q.s. Preservative

1.00 Laureth-3

q.s. Citric acid

2.00 Sodium chloride

Preparation:

Mix the components of phase A. Add the components of phase B one after the other and mix. Adjust the pH to 6-7.

### Example 30

### Liquid Soap

A

44.06 Aqua, demin.

0.34 Aminomethyl propanol

3.40 Acrylates copolymer

B

40.00 Sodium laureth sulfate

10.00 Cocamidopropyl betaine

0.20 Dispersion according to the invention

q.s. Perfume oil

q.s. Preservative

2.00 Sodium chloride

Preparation:

Weigh in the components of phase A and dissolve until clear. Add the components of phase B one after the other and mix.

### Example 31

### Liquid Foot Bath

A

1.00 Nonoxynol-14

0.10 Bisabolol

1.00 Pine (Pinus sylvestris) oil

B

5.00 PEG-8

1.20 Dispersion according to the invention

0.50 Triclosan

30.00 Sodium laureth sulfate

3.00 Polyquaternium-16

58.20 Aqua, demin.

q.s. C. I. 19 140+C. I. 42 051

Preparation:

Solubilize phase A. Mix phase B.

### Example 32

### Freshening Gel

A

0.60 Carbomer

45.40 Aqua, demin.

B

0.50 Bisabolol

0.50 Farnesol

q.s. Perfume oil

5.00 PEG-40 Hydrogenated Castor Oil

0.50 Dispersion according to the invention

1.00 Tetrahydroxypropylethylenediamine

1.50 Menthol

45.00 Alcohol

q.s. C. I. 74 180, Direct Blue 86

Preparation:

Allow phase A to swell. Dissolve phase B. Stir phase B into phase A.

### Example 33

### Roll-On Antiperspirant

A

0.40 Hydroxyethylcellulose

50.00 Aqua, demin.

B

25.00 Alcohol

0.10 Bisabolol

0.30 Farnesol

2.00 PEG-40 Hydrogenated castor oil

q.s. Perfume oil

C

5.00 Aluminum chlorohydrate

3.00 Propylene glycol

3.00 Dimethicone copolyol

3.00 Polyquaternium-16

1.20 Dispersion according to the invention

7.00 Aqua, demin.

Preparation:

Allow phase A to swell. Separately dissolve phase B and C. Stir phase A and B into phase C.

### Example 34

### Transparent Deodorant Stick

5.00 Sodium stearate

0.50 Triclosan

3.00 Ceteareth-25

20.00 Glycerol

0.50 Dispersion according to the invention

q.s. Perfume oil

60.00 Propylene glycol

0.20 Bisabolol

10.80 Aqua, demin.

Preparation:

Weigh phase A together, melt and homogenize. Then pour into the mold.

### Example 35

### Water-Soluble Bath Oil

15.00 Cetearyl octanoate

15.00 Caprylic/capric triglyceride

1.00 Panthenol, propylene glycol

0.10 Bisabolol

2.00 Tocopheryl acetate

2.00 Retinyl palmitate

0.10 Tocopherol

37.00 PEG-7 glyceryl cocoate

0.40 Dispersion according to the invention

3.80 Aqua, demin.

q.s. Perfume oil

23.60 PEG-40 Hydrogenated castor oil

Preparation:

Mix and stir until everything has dissolved to give a clear solution.

### Example 36

### Daycare Aerosol

A

4.00 Ethylhexyl methoxycinnamate

1.50 Octocrylene

9.00 Caprylic/capric triglyceride

5.00 Simmondsia Chinensis (jojoba) seed oil

1.50 Cyclomethicone

3.00 Hydrogenated coco glycerides

1.00 PVP/hexadecene copolymer

1.00 Ceteareth-6, stearyl alcohol

B

5.00 Zinc oxide

C

2.00 Ceteareth-25

1.20 Panthenol

0.20 Sodium ascorbyl phosphate

0.30 Imidazolidinylurea

0.10 Disodium EDTA

1.50 Dispersion according to the invention

62.67 Aqua, demin.

D

0.50 Tocopheryl acetate

0.20 Bisabolol

0.33 Caprylic/capric triglyceride, retinol

q.s. Perfume oil

Preparation:

Heat phase A to 80° C. Dissolve phase A until clear. Incorporate phase B and homogenize. Add phase C, heat to 80° C., melt and homogenize. Cool to about 40° C. with stirring, add phase D and briefly homogenize. Bottle with 90% active ingredient solution: 10% propane/butane at 3.5 bar (20° C.).

### Example 37

### Moisturizing Cream

A

3.00 Vitis Vinifera (grape) seed oil

1.00 Cyclopentasiloxane, cyclohexasiloxane

1.50 Cyclomethicone

2.00 Soybean (Glycine soja) oil

2.00 Ethylhexyl methoxycinnamate

1.00 Uvinul A Plus (BASF)

1.00 Hydrogenated lecithin

1.00 Cholesterol

2.00 PEG-40 hydrogenated castor oil

5.00 Cetearyl octanoate

5.00 Caprylic/capric triglyceride

B

3.00 Caprylic/capric triglyceride, acrylates copolymer

C

3.00 Dispersion according to the invention

0.50 Cocotrimonium methosulfate

2.00 Panthenol, propylene glycol

3.00 Glycerol

0.10 Disodium EDTA

60.30 Aqua, demin.

D

0.30 Perfume

0.30 DMDM hydantoin

1.00 Tocopheryl acetate

2.00 Tocopherol

Preparation:

Heat phase A to 80° C. Stir phase B into phase A. Heat phase C to about 80° C. and stir into phase A+B with homogenization. Cool with stirring to about 40° C., add phase D and briefly homogenize.

### Example 38

### Aerosol Hair Mousse

A

2.00 Cocotrimonium methosulfate

0.20 Perfume oil

B

63.90 Aqua, demin.

6.70 Dispersion according to the invention

0.50 Acrylates copolymer

0.10 Aminomethylpropanol

0.20 Ceteareth-25

0.20 Trimethylsilylamodimethicone, Trideceth-10, cetrimonium chloride

0.10 PEG-25 PABA

0.20 Hydroxyethylcellulose

0.20 PEG-8

0.20 Panthenol

15.00 Alcohol

C

10.00 Propane/butane 3.5 bar (20° C.)

Preparation:

Mix phases A and B and bottle with propellant gas.

### Example 39

### Pump Mousse

A

2.00 Cocotrimonium methosulfate

q.s. Perfume oil

C

86.30 Aqua, demin.

7.00 Polyquaternium-46

3.00 Dispersion according to the invention

0.50 PEG-8

1.00 Panthenol

q.s. Preservative

0.20 PEG-25 PABA

Preparation:

Mix the components of phase A. Add the components of phase B one after the other and dissolve until clear.

### Example 40

### Aerosol Mousse

15.00 Dispersion according to the invention

5.00 PVPNA copolymer

0.50 Hydroxyethylcetyldimonium phosphate

0.20 Ceteareth-25

0.40 Perfume oil PC 910.781/cremophor

68.90 Aqua, demin.

q.s. Preservative

10.00 Propane/butane 3.5 bar (20° C.)

Preparation:

Weigh everything together, stir until dissolved, then bottle.

### Example 41

### Color Styling Mousse

A

2.00 Cocotrimonium methosulfate

q.s. Perfume oil

B

6.70 Dispersion according to the invention

0.50 Acrylates copolymer,

0.10 Aminomethylpropanol

0.20 Ceteareth-25

0.20 Panthenol

0.20 Hydroxyethylcellulose

10.00 Alcohol

69.97 Aqua, demin.

0.08 C.I. 12245, Basic Red 76

0.05 C.I. 42510, Basic Violet 14

C

10.00 Propane/butane 3.5 bar (20° C.)

Preparation:

Weigh everything together, stir until dissolved, then bottle.

Only suitable for dark blonde and brown hair!

### Example 42

### Aerosol Hair Mousse

A

0.20 Perfume oil

2.00 Cocotrimonium methosulfate

B

69.90 Aqua, demin.

14.70 Polyurethane-1

2.00 Dispersion according to the invention

0.50 PEG-25 PABA

0.20 Amodimethicone, tallowtrimonium chloride, nonoxynol-10

q.s. Preservative

0.50 Ceteareth-25

C

10.00 Propane/butane 3.5 bar (20° C.)

Preparation:

Mix phase A. Add the components of phase B one after the other and dissolve. Bottle with phase C.

### Example 43

### Pump Hair Mousse

A

1.50 Cocotrimonium methosulfate

q.s. Perfume oil

B

2.00 Dispersion according to the invention

94.04 Aqua, demin.

C

0.46 Aminomethylpropanol

4.00 PEG/PPG-25/25 dimethicone/acrylates copolymer

q.s. Preservative

Preparation:

Mix phase A. Stir phase B into phase A. Add phase C and stir until dissolved.

### Example 44

### Hairstyling Gel

A

0.50 Carbomer

87.60 Aqua, demin.

B

0.70 Triethanolamine

C

6.00 Dispersion according to the invention

5.00 PVP (Luviskol K30 or Luviskol K90)

q.s. Perfume oil

q.s. PEG-40 hydrogenated castor oil

q.s. Preservative

0.10 Tocopheryl acetate

Preparation:

Allow phase A to swell and neutralize with phase B. Dissolve phase C and stir into phase A+B.

### Example 45

### Hairstyling Gel

A

0.50 Carbomer

87.60 Aqua, demin.

B

0.90 Tetrahydroxypropylethylenediamine

C

2.00 Dispersion according to the invention

9.00 VP/VA copolymer (Luviskol VA64W; BASF)

q.s. Perfume oil

q.s. PEG-40 hydrogenated castor oil

q.s. Preservative

0.10 Propylene glycol

Preparation:

Allow phase A to swell and neutralize with phase B. Dissolve phase C and stir into phase A+B.

### Example 46

### Hairstyling Gel

2.00 Dispersion according to the invention

6.00 Corn starch modified (Amaze, National Starch)

0.50 Chitosan

q.s. Perfume oil

q.s. PEG-40 hydrogenated castor oil

0.10 PEG-14 dimethicone

0.10 Preservative

91.40 Aqua, demin.

Preparation:

Mix all of the components until they are homogeneous.

### Example 47

### Hairstyling Gel

8.00 Dispersion according to the invention

5.00 VP/DMAPA acrylates copolymer (ISP: Styleze CC-10)

0.05 Aminomethylpropanol

84.85 Aqua, demin.

q.s. Perfume oil

q.s. PEG-40 hydrogenated castor oil

0.10 Dimethicone copolyol

0.10 Preservative

2.00 Hydroxypropylcellulose

Preparation:

Mix all of the components until they are homogeneous.

### Example 48

### Hairstyling Gel

6.00 Dispersion according to the invention

1.00 VP/acrylates/lauryl methacrylate copolymer (ISP: Styleze 2000)

0.26 Aminomethylpropanol

90.64 Aqua, demin.

q.s. Perfume oil

q.s. PEG-40 hydrogenated castor oil

0.10 Sorbitol

0.10 Preservative

2.00 Hydroxypropylguar (Rhodia Inc., N-Hance Hydroxypropylguar)

Preparation:

Mix all of the components until they are homogeneous.

### Example 49

### Hair Gel

A

0.50 Carbomer

90.01 Aqua, demin.

B

0.70 Triethanolamine

C

6.00 Dispersion according to the invention

2.00 Acrylates/C1-2 succinates/hydroxyacrylates copolymer (Rohm&Haas, Allianz LT-120)

0.19 Aminomethylpropanol

q.s. Perfume oil

q.s. PEG-40 hydrogenated castor oil

0.10 PEG-8

0.10 Preservative

0.50 Hydroxyethylcellulose

Preparation:

Allow phase A to swell and neutralize with phase B. Dissolve phase C and stir into phase A+B.

### Example 50

### Hair Gel

7.00 Dispersion according to the invention

7.00 Methacrylic acid/sodium acrylamidomethylpropanesulfonate copolymer (Ondeo Nalco, Fixomer A30)

0.70 Triethanolamine

q.s. Perfume oil

q.s. PEG-40 hydrogenated castor oil

0.10 Panthenol

0.10 Preservative

84.90 Aqua, demin.

1.00 Polyacrylamide/C13-14 isoparaffin/laureth-7 (Seppic, Sepigel 305)

Preparation:

Mix all of the components until they are homogeneous.

### Example 51

### Hair Gel

A

0.50 Carbomer

90.50 Aqua, demin.

B

0.70 Triethanolamine

C

7.00 Dispersion according to the invention

1.00 Polyvinylformamide

q.s. Perfume oil

q.s. PEG-40 hydrogenated castor oil

0.10 Preservative

0.10 Ethylhexyl methoxycinnamate

0.10 PEG-14 dimethicone

Preparation:

Allow phase A to swell and neutralize with phase B. Dissolve phase C and stir into phase A+B.

### Example 52

### Aquawax

10.00 Copolymer according to the invention

q.s. Perfume oil

q.s. PEG-40 hydrogenated castor oil

0.10 Diethyl phthalate

0.10 Cetearyl ethylhexanoate

0,10 PEG-7 glyceryl cocoate

0.10 Preservative

87.70 Aqua, demin.

2.00 Caprylic/capric triglyceryde, acrylates copolymer

Preparation:

Mix everything and homogenize. After-stir for 15 minutes.

### Example 53

### Rinse-Off Conditioner and Repair Treatment

A

0.20 Cetearyl octanoate

0.10 Phytantriol

2.00 PEG-40 hydrogenated castor oil

B

q.s. Perfume oil

2.00 Cocotrimonium methosulfate

C

77.70 Aqua, demin.

D

2.00 Polyquaternium-16

5.00 Dispersion according to the invention

1.00 Dimethicone copolyol

q.s. Preservative

10.00 Alcohol

q.s. Citric acid

Preparation:

Separately mix phases A and B. Stir phase C into phase B.

### Example 54

### Hair Treatment

A

2.00 Ceteareth-6, stearyl alcohol

1.00 Ceteareth-25

6.00 Cetearyl alcohol

6.00 Cetearyl octanoate

0.30 Phytantriol

B

5.00 Dispersion according to the invention

0.70 Guar hydroxypropyltrimonium chloride

5.00 Propylene glycol

2.00 Panthenol

0.30 Imidazolidinyiurea

69.00 Aqua, demin.

C

2.00 Cosi Silk Soluble

0.20 Perfume

0.50 Phenoxyethanol

Preparation:

Heat phases A and B separately to about 80° C. Homogenize phase B.

### Example 55

### Hair Cocktail

A

0.40 Acrylates/C10-30 alkyl acrylate crosspolymer

2.00 Dimethicone

3.00 Cyclomethicone, dimethiconol

2.00 Phenyltrimethicone

2.00 Amodimethicone, cetrimonium chloride, trideceth-10

0.50 Dimethicone copolyol

1.00 Macadamia (Ternifolia) nut oil

0.50 Tocopheryl acetate

1.00 PEG-40 hydrogenated castor oil

q.s. Perfume oil

B

82.84 Aqua, demin.

0.30 Dispersion according to the invention

0.46 Aminomethylpropanol

4.00 PEG/PPG-25/25 dimethicone/acrylates copolymer

Preparation:

Mix the components of phase A. Dissolve phase B. Stir phase B with homogenization into phase A

### Example 56

### Permanent Wave

Waving Solution

A

73.95 Aqua, demin.

0.20 Cocamidopropylbetaine

0.20 Polysorbate 20

1.25 Dispersion according to the invention

0.20 Disodium EDTA

0.20 Hydroxyethylcellulose

B

8.00 Thioglycolic acid

C

11.00 Ammonium hydroxide

D

5.00 Ammonium carbonate

Preparation:

Weigh in the components of phase A and dissolve until clear. Stir phase B into phase A.

Neutralization:

A

1.00 PEG-40 hydrogenated castor oil

0.20 Perfume oil

93.60 Aqua, demin.

B

0.20 Cocamidopropylbetaine

0.20 Ceteareth-25

2.50 Dispersion according to the invention

q.s. Preservative

C

2.30 Hydrogen peroxide

D

q.s. Phosphoric acid

Preparation:

Solubilize phase A. Add the components of phase B one after the other and dissolve until clear.

### Example 57

### Dark-Brown Permanent Hair Color (Oxidation Hair Color)

A

50.90 Aqua, demin.

0.20 Sodium sulfite

0.05 Disodium EDTA

0.20 p-Phenylenediamine

0.30 Resorcinol

0.20 4-Amino-2-hydroxytoluene

0.10 m-Aminophenol

1.50 Oleyl alcohol

4.50 Propylene glycol

2.30 Sodium C12-15 pareth-15 sulfonate

20.00 Oleic acid

B

1.00 Dispersion according to the invention

13.70 Ammonium hydroxide

6.00 i-Propanol

q.s. Perfume

Preparation:

Solubilize phase A. Add the components of phase B one after the other and mix.

Developer Emulsion (pH: 3-4)

3.00 Hexadecyl alcohol

2.00 Dispersion according to the invention

1.00 Ceteareth-20

1.00 Sodium C12-15 pareth-15 sulfonate

6.00 Hydrogen peroxide

0.50 Phosphoric acid

0.01 Acetanilide

86.49 Aqua, demin.

Preparation:

Add the components together and mix.

### Example 58

### Pale Brown Semipermanent Hair Color

10.00 Cocodiethanolamide

4.00 Sodium dodecylbenzoylsulfonate, 50% strength

1.00 Dispersion according to the invention

6.00 C9-11 pareth-3

2.50 Sodium lauryl sulfate

0.4 2-Nitro-p-phenylendiamine

0.20 HC Red No. 3

0.20 HC Yellow No. 2

75.70 Aqua, demin.

Preparation:

Add the components together and mix.

### Example 59

### Clear Conditioning Shampoo

A

15.00 Cocamidopropylbetaine

10.00 Disodium cocoamphodiacetate

5.00 Polysorbate 20

5.00 Decyl glucoside

q.s. Perfume

q.s. Preservative

0.1-1.0 Dispersion according to the invention

2.00 Laureth-3

ad 100 Aqua, demin.

q.s. Citric acid

B

3.00 PEG-150 distearate

Preparation:

Weigh in the components of phase A and dissolve. Adjust pH to 6-7. Add phase B and heat to 50° C. Allow to cool to room temperature with stirring.

### Example 60

### Shampoo

30.00 Sodium laureth sulfate
6.00 Sodium cocoamphoacetate
6.00 Cocamidopropylbetaine
3.00 Sodium laureth sulfate, glycol distearate, cocamide MEA, laureth-10
0.1-1.0 Dispersion according to the invention
2.00 Dimethicone
q.s. Perfume
q.s. Preservative
q.s. Citric acid
1.00 Sodium chloride
ad 100 Aqua, demin.
   Preparation:

Weigh in and dissolve the components. Adjust the pH to 6-7.

### Example 61

### Shampoo

30.00 Sodium laureth sulfate
6.00 Sodium cocoamphoacetate
6.00 Cocamidopropylbetaine
3.00 Sodium laureth sulfate, glycol distearate, cocamide MEA, laureth-10
0.1-1.0 Dispersion according to the invention
2.00 Amodimethicone
q.s. Perfume
q.s. Preservative
q.s. Citric acid
1.00 Sodium chloride
ad 100 Aqua, demin.
   Preparation:

Weigh in and dissolve the components. Adjust the pH to 6-7.

### Example 62

### Shampoo

40.00 Sodium laureth sulfate
10.00 Cocamidopropylbetaine
3.00 Sodium laureth sulfate, glycol distearate, cocamide MEA, laureth-10
0.1-1.0 Dispersion according to the invention
2.00 Dow Corning 3052
q.s. Perfume
q.s. Preservative
q.s. Citric acid
2.00 Cocamido DEA
ad 100 Aqua, demin.
   Preparation:

Weigh in and dissolve the components. Adjust the pH to 6-7.

### Example 63

### Anti-Dandruff Shampoo

0.00 Sodium laureth sulfate

0.00 Cocamidopropylbetaine

10.00 Disodium laureth sulfosuccinate

2.50 Sodium laureth sulfate, glycol distearate, cocamide MEA, laureth-10

0.1-1.0 Dispersion according to the invention

0.50 Climbazole

q.s. Perfume

q.s. Preservative

0.50 Sodium chloride

ad 100 Aqua, demin.

Preparation:

Weigh in and dissolve the components. Adjust the pH to 6-7.

### Example 64

### Shampoo

25.00 Sodium laureth sulfate

5.00 Cocamidopropylbetaine

2.50 Sodium laureth sulfate, glycol distearate, cocamide MEA, laureth-10

0.1-1.0 Dispersion according to the invention

q.s. Perfume

q.s. Preservative

2.00 Cocamido DEA

ad 100 Aqua, demin.

Preparation:

Weigh in and dissolve the components. Adjust the pH to 6-7.

### Example 65

### Shampoo

20.00 Ammonium laureth sulfate

15.00 Ammonium lauryl sulfate

5.00 Cocamidopropylbetaine

2.50 Sodium laureth sulfate, glycol distearate, cocamide MEA, laureth-10

0.1-1.0 Dispersion according to the invention

q.s. Perfume

q.s. Preservative

0.50 Sodium chloride

ad 100 Aqua, demin.

Preparation:

Weigh in and dissolve the components. Adjust the pH to 6-7.

### Example 66

### Clear Shower Gel

40.00 Sodium laureth sulfate

5.00 Decyl glucoside

5.00 Cocamidopropylbetaine

0.1-1.0 Dispersion according to the invention

1.00 Panthenol

q.s. Perfume

q.s. Preservative

q.s. Citric acid

2.00 Sodium chloride

ad 100 Aqua, demin.

Preparation:

Weigh in and dissolve the components. Adjust the pH to 6-7.

### Example 67

### Shampoo

12.00 Sodium laureth sulfate

1.50 Decyl glucoside

2.50 Cocamidopropylbetaine

5.00 Cocoglucoside glyceryl oleate

2.00 Sodium laureth sulfate, glycol distearate, cocamide MEA, laureth-10

0.1-1.0 Dispersion according to the invention

q.s. Preservative

q.s. Sunset Yellow C. I. 15 985

q.s. Perfume

1.00 Sodium chloride

ad 100 Aqua, demin.

Preparation:

Weigh in and dissolve the components. Adjust the pH to 6-7.

### Example 68

### Shampoo

A

40.00 Sodium laureth sulfate

5.00 Sodium C12-15 pareth-15 sulfonate

5.00 Decyl glucoside

q.s. Perfume

0.10 Phytantriol

B

ad 100 Aqua, demin.

0.1-1.0 Dispersion according to the invention

1.00 Panthenol

q.s. Preservative

1.00 Laureth-3

q.s. Citric acid

2.00 Sodium chloride

Preparation:

Weigh in and dissolve the components of phase A. Adjust pH to 6-7. Add phase B and mix.

1. An aqueous dispersion obtainable by free-radical polymerization of
a) at least one N-vinyl-containing monomer and/or at least one (meth)acrylamide monomer
b) at least one polymeric dispersant
c) at least one polymeric precipitation agent
d) at least one crosslinker
e) optionally further monomers
f) optionally at least one regulator
g) optionally a buffer substance
where the weight ratio of b) to c) is in the range from 1:50 to 1:0.02.

2. A dispersion as claimed in claim 1, wherein the weight ratio of b) to c) is in the range from 1:20 to 1:0.05.

3. A dispersion as claimed in claim 1, wherein
N-vinylamides and/or
N-vinyllactams and/or
(meth)acrylamide monomers chosen from the group consisting of acrylamide,
2-acrylamidoglycolic acid,
N-(tris(hydroxymethyl)methyl)acrylamide,
N-hydroxymethylacrylamide,
N-methylacrylamide,
N-isopropylacrylamide,
2-acrylamido-2-methyl-1-propanesulfonic acid methacrylamide,
N-ethyl-methacrylamide,
N-hydroxymethylmethacrylamide,
N-(2-hydroxypropyl)methacrylamide,
N-methylmethacrylamide,
N-isobutoxymethylacrylamide,
N-methoxymethylmethacrylamide
are used as monomer a).

4. A dispersion as claimed in claim 1, wherein monomer a) is chosen from the group consisting of acrylamide, methacrylamide, N-hydroxymethylacrylamide, N-(2-hydroxypropyl)methacrylamide, N-hydroxymethylmethacrylamide, N-isopropylacrylamide.

5. A dispersion as claimed in claim 1, wherein the polymeric dispersant b) is chosen from the group consisting of polyvinyl acetate, polyalkylene glycols, in particular polyethylene glycols, polyvinyl alcohol, polyvinylpyridine, polyethyleneimine, polyvinylimidazole, polyvinylsuccinimide and polydiallyldimethylammonium chloride, polyvinylpyrrolidone, polymers which comprise at least 5% by weight of vinylpyrrolidone units, polymers which comprise at least 50% by weight of vinyl alcohol units, oligosaccharides, polysaccharides, oxidatively, hydrolytically or enzymatically degraded polysaccharides, chemically modified oligo-or polysaccharides, such as, in particular, carboxymethylcellulose, water-soluble starch and starch derivatives, starch esters, starch xanthanogenates, starch acetates, dextran, and mixtures thereof.

6. A dispersion as claimed in claim 1, wherein polymers which comprise at least 5% by weight of vinylpyrrolidone units and/or polyvinylpyrrolidone are used as polymeric dispersant b).

7. A dispersion as claimed in claim 1, wherein a water-soluble polyether-containing compound is used as polymeric precipitation agent c).

8. A dispersion as claimed in claim 1, wherein a water-soluble polyether-containing compound of the following formula (Ib) is used as polymeric precipitation agent c): 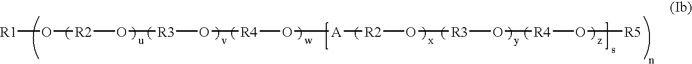
in which the variables, independently of one another, have the following meanings:
R¹ is hydrogen, C₁-C₂₄-alkyl, R⁶—C(═O)—, R⁶—NH—C(═O)—, polyalcohol radical;
R⁵ is hydrogen, C₁-C₂₄-alkyl, R⁶—C(═O)—, R⁶—NH—C(═O)—;
R² to R⁴ are —(CH₂)₂—, —(CH₂)₃—, —(CH₂)₄—, —CH₂—CH(R⁶—, —CH₂—CHOR⁷—CH₂—;
R⁶ is C₁-C₂₄-alkyl;
R⁷ is hydrogen, C₁-C₂₄-alkyl, R⁶—C(═O)—, R⁶—NH—C(═O)—;
A is —C(═O)—O, —C(═O)B—C(═O)—O, —CH₂—CH(—OH)—B—CH(—OH)—CH₂—O, —C(═O)—NH—B—NH—C(═O)—O; 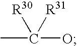
B is —(CH₂)ₜ—, arylene, optionally substituted;
R³⁰, R³¹ are hydrogen, C₁-C₂₄-alkyl, C₁-C₂₄-hydroxyalkyl, benzyl or phenyl;
n is 1 when R¹ is not a polyalcohol radical or
n is 1 to 1000 when R¹ is a polyalcohol radical
s=0 to 1000; t=to 12; u=1 to 5000; v=0 to 5000; w=0 to 5000; x=to 5000;
y=0 to 5000;z=0 to 5000.

9. A dispersion as claimed in claim 1, wherein polyalkylene glycols are used as polymeric precipitation agent c).

10. A dispersion of claim 1, wherein polyethylene glycol (PEG) is used as polymeric precipitation agent c).

11. A dispersion as claimed in claim 1, wherein a compound with a molecular weight of from 300 to 100 000, preferably 1000 to 30 000, in particular 1000 to 10 000, is used as polymeric precipitation agent c).

12. A dispersion as claimed in claim 1, wherein the weight ratio of the sum of b) and c) to the sum of the remaining monomers is in the range from 10:1 to 1:0.1.

13. A dispersion as claimed in claim 1, wherein a cationic and/or a quaternizable monomer is used as further monomer e).

14. A dispersion as claimed in claim 13, wherein a diallylamine of the formula (II), in which R⁴ is C₁-C₂₄-alkyl is used as further monomer e)

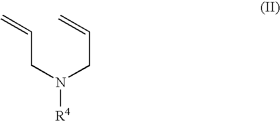

15. A dispersion as claimed in claim 13, wherein an N-vinylimidazole derivative of the formula (II) in which R¹ to R³ is hydrogen, C₁-C₄-alkyl or phenyl is used as further monomer e).

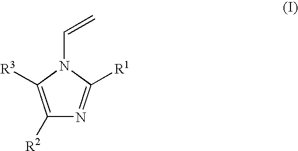

16. A dispersion as claimed in claim 1, wherein polymers which comprise at least 5% by weight of vinylpyrrolidone units and/or polyvinylpyrrolidone are used as polymeric dispersant b), and polyethylene glycol is used as precipitation agent c).

17. An aqueous solution obtainable by diluting the dispersion as claimed in claim 1 with water.

18. A process for the preparation of aqueous dispersions where
a) at least one N-vinyl-containing monomer and/or at least one (meth)acrylamide monomer
b) at least one polymeric dispersant
c) at least one precipitation agent
d) at least one crosslinker
e) optionally further monomers
g) optionally a buffer substance
are reacted in the presence of at least one regulator f) and the weight ratio of b) to c) is in the range from 1:50 to 1:0.02.

19. A process as claimed in claim 18, wherein a multifunctional regulator is used as regulator f).

20. A process as claimed in claim 18, wherein the resulting dispersion is subjected to hydrolysis.

21. A process as claimed in claim 20, wherein the hydrolysis is carried out up to a content of amines in the polymer of <20 mol %, based on component (a).

22. The use of aqueous dispersions as claimed in claim 1 in cosmetic preparations, in particular in hair cosmetic preparations.

23. The use of aqueous dispersions obtainable by free-radical polymerization of
a) at least one (meth)acrylamide monomer and optionally at least one N-vinyl-containing monomer
b) at least one polymeric dispersant
c) at least one polymeric precipitation agent
e) optionally further monomers
f) optionally at least one regulator
g) optionally in the presence of a buffer substance
where the weight ratio of b) to c) is in the range from 1:50 to 1:0.02 in cosmetic preparations, in particular in hair cosmetic preparations.

24. The use as claimed in claim 23, where the at least one monomer a) is as defined in claim 3.

25. The use as claimed in claim 23, where the polymeric dispersant b) and the polymeric precipitation reagent c) are as defined in claim 2.

26. The use as claimed in claim 23, where the further monomer e) is as defined in claim 13.

27. The use as claimed in as thickener claim 22.

28. The use as claimed in claim 22 as conditioning agent.

29. A method of increasing the viscosity of a preparation by adding an aqueous dispersion according to claim 1 or by adding an aqueous dispersion according to claim 23 to the preparation and the addition of water.

30. A method as claimed in claim 29, wherein at least 2 parts by weight of water, based on the dispersion, are added to the preparation.

31. A cosmetic composition comprising, in a cosmetically acceptable medium, at least one aqueous dispersion as claimed in claim 1.

32. A cosmetic composition comprising, in a cosmetically acceptable medium, at least one aqueous dispersion obtainable by free-radical polymerization of
a) at least one (meth)acrylamide monomer and optionally at least one N-vinyl-containing monomer
b) at least one polymeric dispersant
c) at least one polymeric precipitation agent
e) optionally further monomers
f) optionally at least one regulator
g) optionally in the presence of a buffer substance
where the weight ratio of b) to c) is in the range from 1:50 to 1:0.02 and where the at least one monomer a) is as defined in claim 3, the polymeric dispersant b) and the polymeric precipitation reagent c) are as defined in claim 2 and the further monomer e) is as defined in claim 13.
